(19) United States
(12) Patent Application Publication
(10) Pub. No.: US 2014/0236860 A1
(43) Pub. Date: Aug. 21, 2014

(54) system allowing banks to diversify their loan portfolios via exchanging loans

(71) Applicant: Ray Camrass, Mount Colah (AU)

(72) Inventor: Ray Camrass, Mount Colah (AU)

(21) Appl. No.: 13/769,997

(22) Filed: Feb. 19, 2013

(51) Int. Cl. G06Q 40/04; G06Q 40/06

(52) U.S. Cl. CPC G06Q 40/04; G06Q 40/06
USPC 705/36 R

(57) ABSTRACT

A method of measuring concentration capital in a bank's loan portfolio and facilitating exchanging of loans, is described. Banks exchange their loans with each other in order to reduce their portfolio's concentration capital and keep within their lending limits. The banks exchange loans in their portfolio using Web pages over the internet or via spreadsheets. The present invention also allows a bank to originate a loan with another bank, thereby avoiding concentration capital and breaching credit limits The present invention also facilitates the securitization of loans from their portfolio into vehicles that include Collateralized Debt Obligations, thereby again reducing concentration capital and adhering to credit limits. By exchanging loans, the diversification of the bank's portfolios protects the bank from the chance of a large financial “systemic event”, industry category, or group of borrowers, to which the bank would currently be exposed. It also reduces the concentration capital needed.

### FIELD OF INVENTION

The field of the invention relates to a bank's loan portfolios, and more specifically, the controlling of credit risk within the loans and reducing losses of a loan portfolio.

### BACKGROUND

Institutional and Corporate Bank's have to manage portfolios of their loans to clients running into tens or even hundreds of billions of dollars. The bank is susceptible to a number of risks when managing their loan portfolios. There is “stand alone” risk that a loan will default (not be repaid) and there are a number of mechanisms in place to address this risk including ratings from companies such as Moody's, Standard and Poor's and Fitch. The ratings tell the bank the probability that the loan will default as a “stand alone” risk but not how the portfolio will respond to systemic event which may affect one or more concentrations simultaneously. Many banks currently have large amounts of loans concentrated in the same country, category of industry and group of borrowers.

### SUMMARY OF THE INVENTION

The present technology addresses an issue of “concentration capital” in addition to the capital required for a loan's “stand-alone” risk. This concentration capital of a loan is a result of the bank concentrating too many loans in one geographic region, industry or sub-industry. The bank's need for concentration capital can be likened to the bank having “too many eggs in a one basket”. Each egg has a chance cracking on its own (“stand alone risk”) with a small effect on the overall portfolio, but in addition to this risk inherent in a single loan, there is an additional risk that the basket will fall and all the eggs will be lost at once (“concentration risk”), or in portfolio terms a country or industrial category or other group, will essentially collapse taking most of the whole group of loans with it, in one event. This concentration risk can even threaten the bank's ability to stay in business as in the case of the Global Financial Crisis. Concentration Capital is the capital needed to address the extra penalty for lending disproportionately to one geographic area or industry group or other grouping of loans. If a bank is heavily concentrated in one group the whole portfolio and every loan is at more at risk than if the bank was diversified across many geographic regions, industries or other groupings. The invention therefore relates to banks and their need to reduce concentration capital in their loan portfolios. This invention allows the bank to quantify their concentration as an amount of money, referred to as “concentration capital”, that they have to keep in reserve to pay for the concentrations in their loan portfolio.

The present invention also allows the bank to be put in touch over the internet with another bank of their choosing, often with entirely different risk concentrations. A “counterparty bank” is another bank with which they would like to exchange loans or perform “remote origination” with (see below). A “bank” includes all banks, deposit-taking and lending institutions. “Borrower” includes all types of “obligor” to the bank—a party which owes a financial amount to the bank whether through borrowing or other debt. “Obligor” is a company or individual with an exposure to the bank, for instance owing money through a trading position with the bank. An example would be an Interest rate swap (swapping a fixed interest rate for floating interest rate) where the borrower owed money to the bank through unrealized losses on the deal.

The present invention then allows both banks to exchange their loans with each other, via an electronic system running over the internet, in order to mutually reduce their own portfolio's concentration risk and the resulting concentration capital to be set aside for it. The present invention also allows the banks to immediately view the net effects of the exchanges of loans on their own portfolio and a counterparty bank's portfolios. The aim of exchanging loans is to diversify the risk concentrations in both their portfolios and jointly reduce the cost of their portfolio's overall concentration capital.

The present invention results in both banks simultaneously reducing the concentration capital in their loan portfolios (i.e. reducing their risk concentrations) resulting in a substantial saving of capital. As the loan portfolios can be in the hundreds of billions of dollars, a modest saving in concentration capital, in percentage terms (such as ½ to seven percent) net savings can run into billions of dollars.

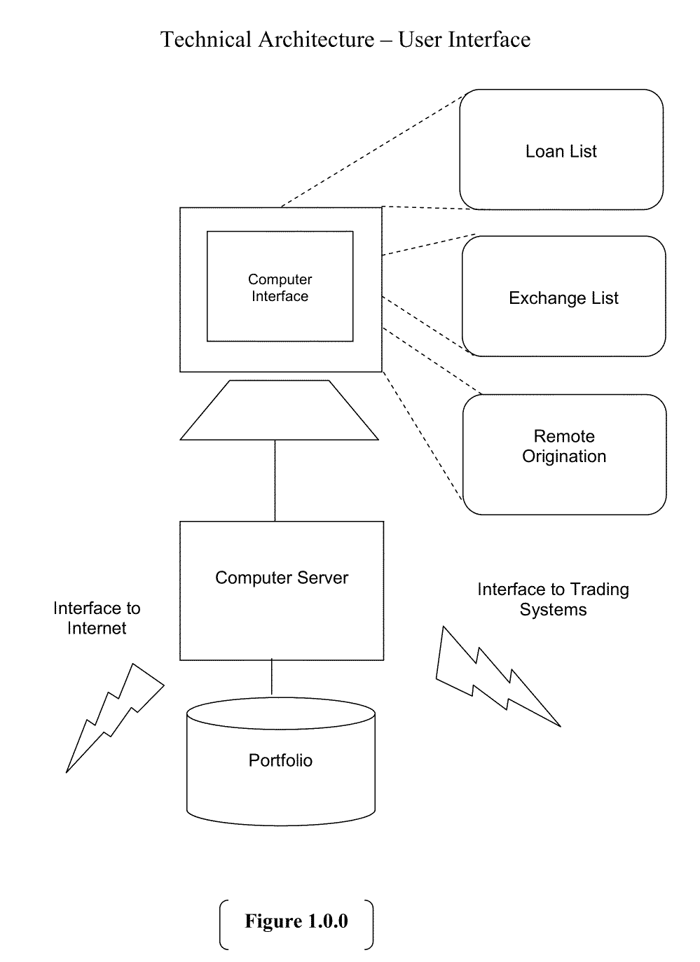

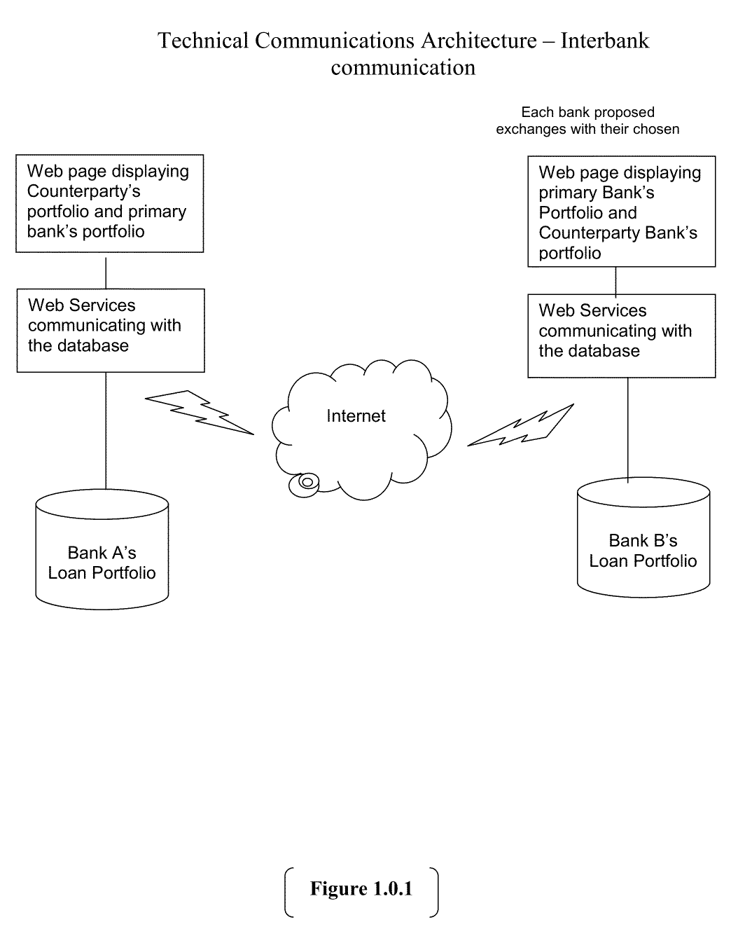

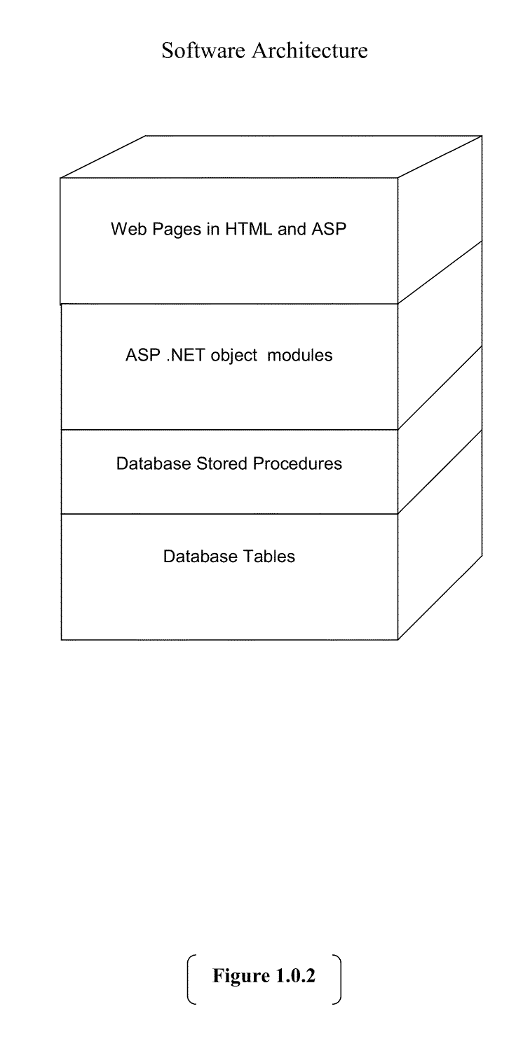

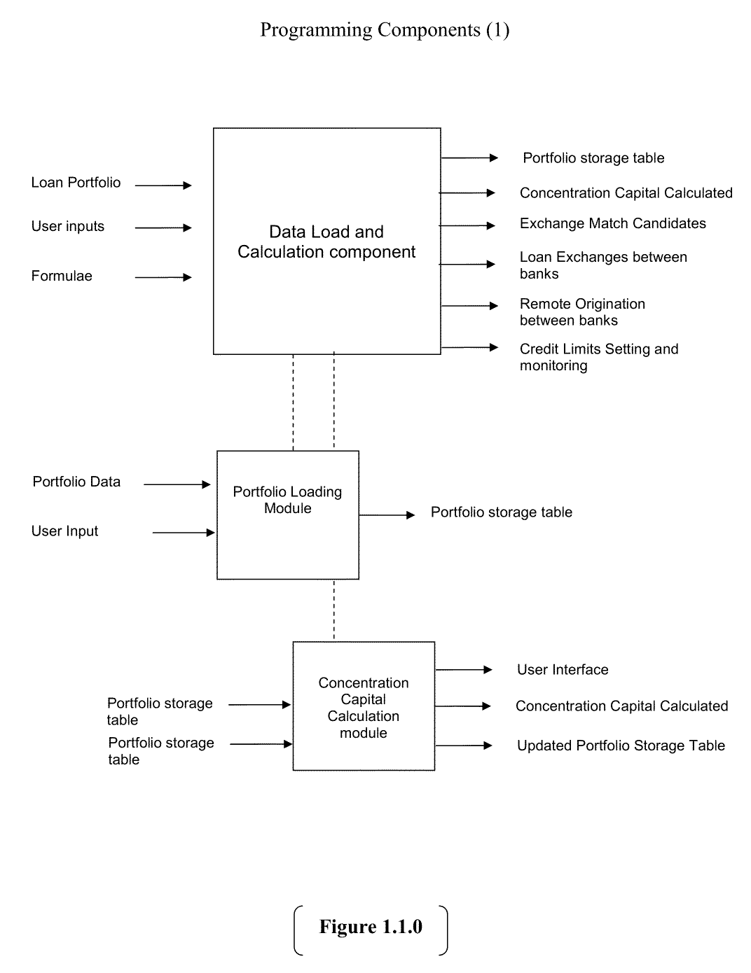

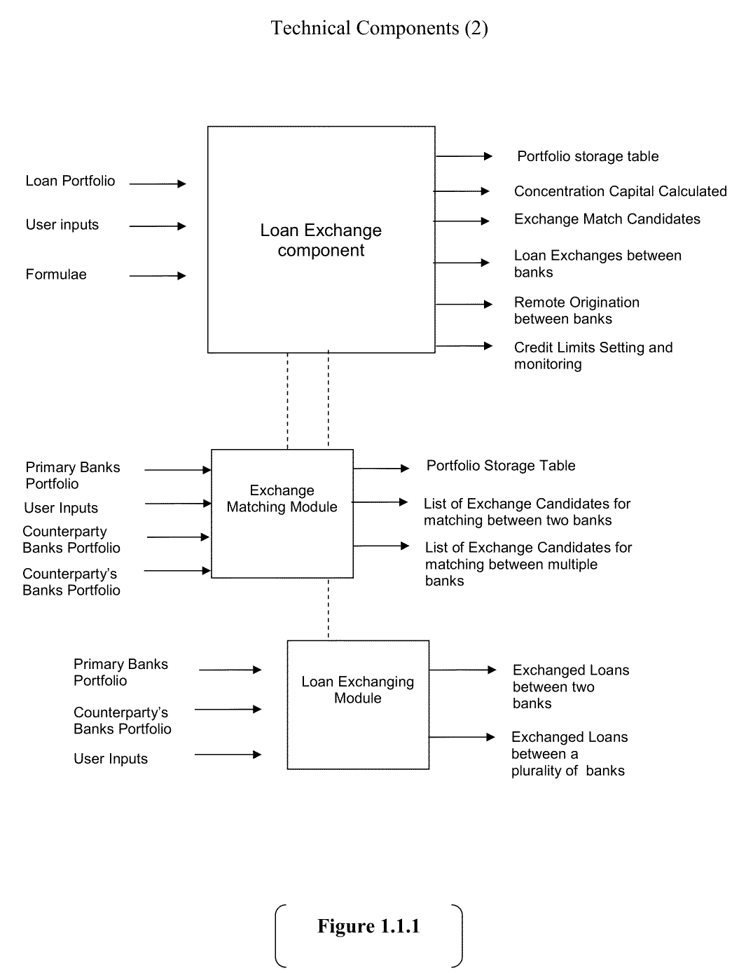

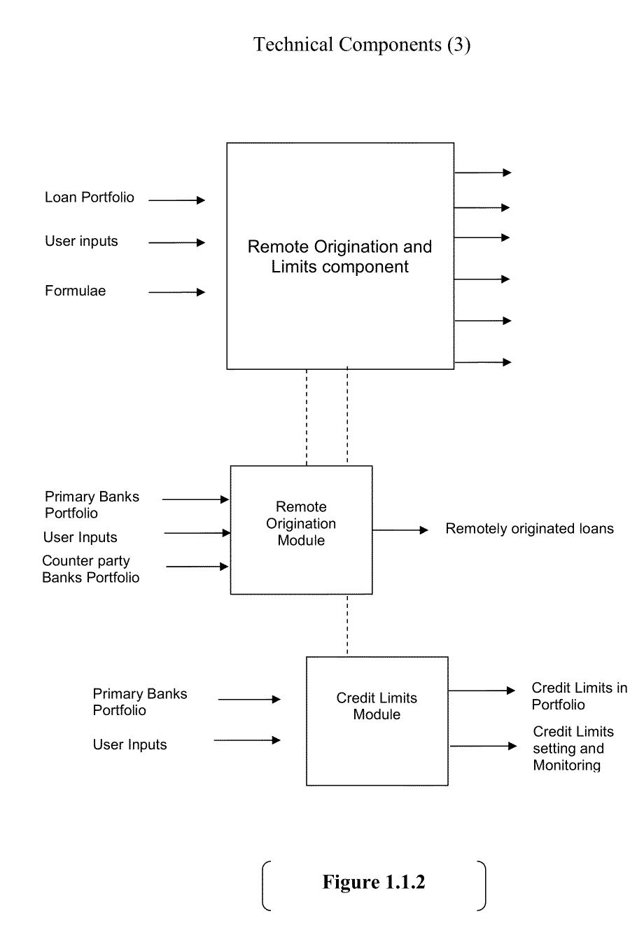

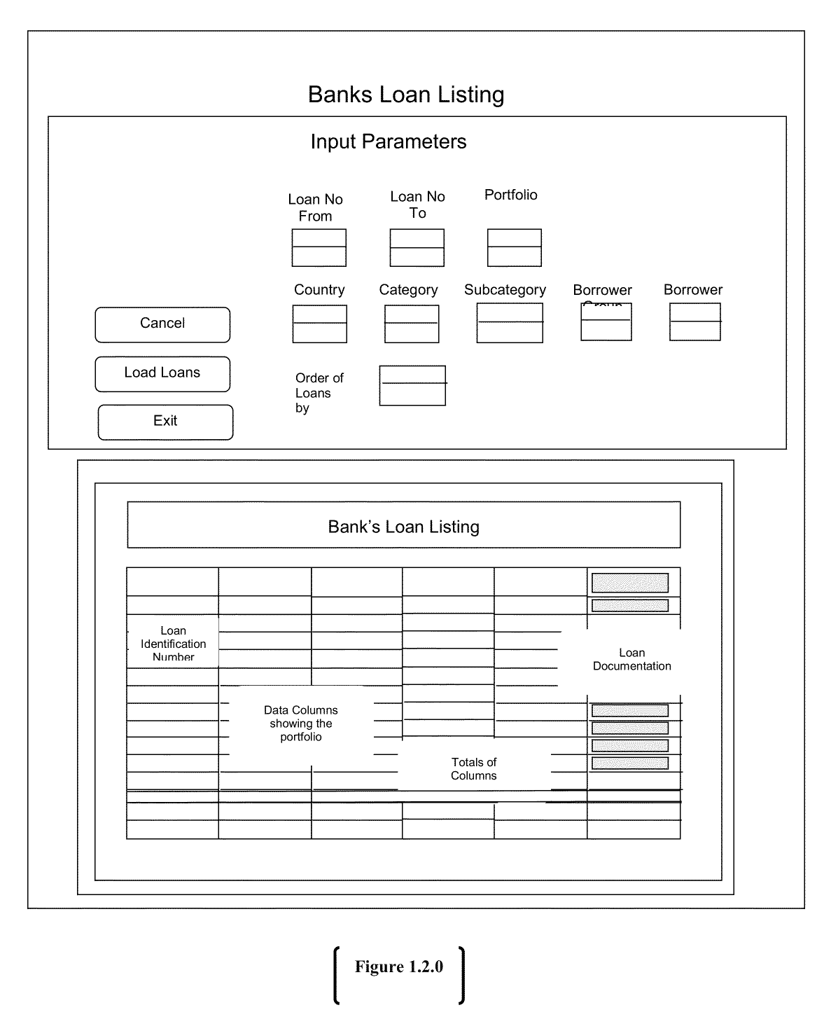

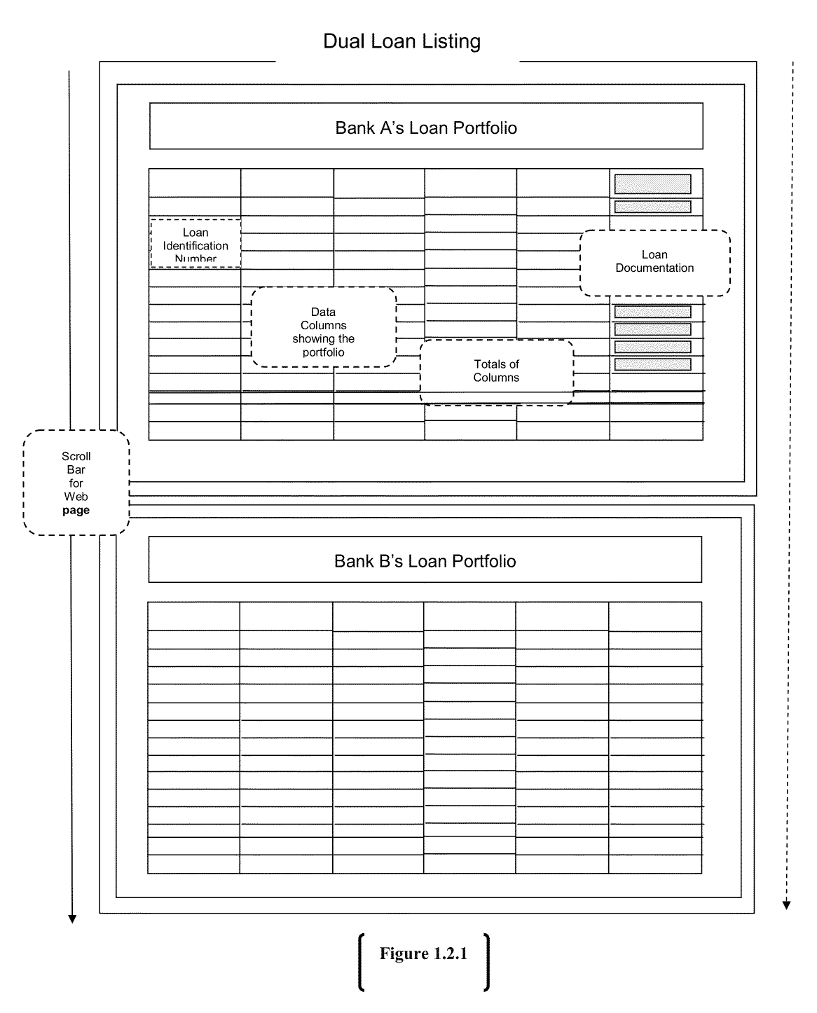

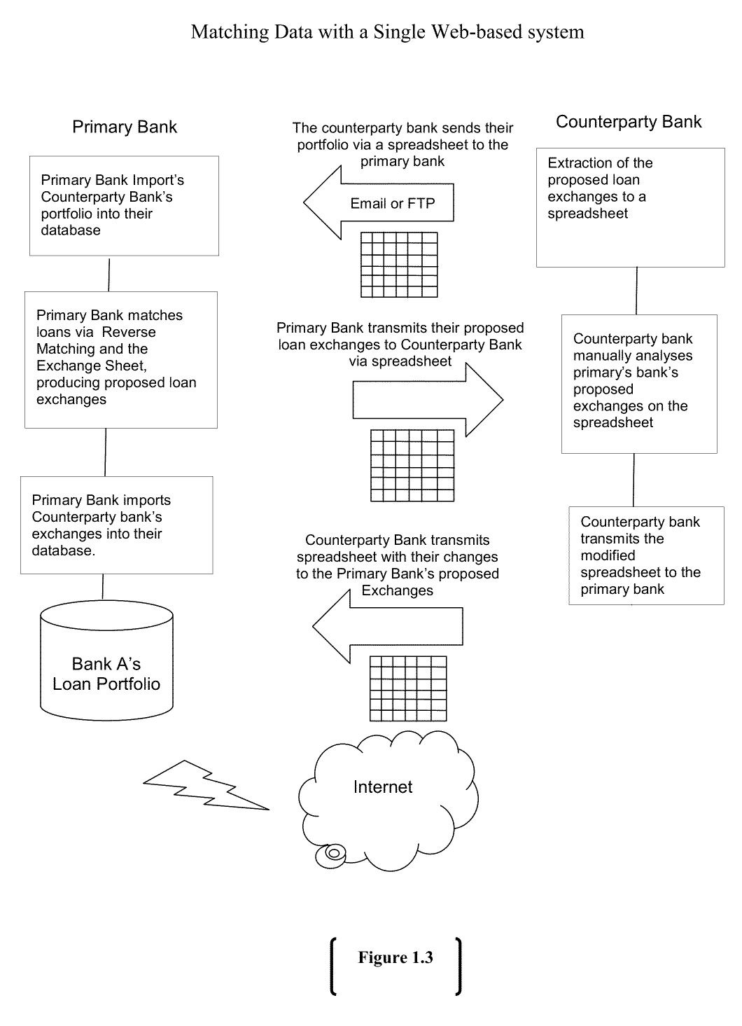

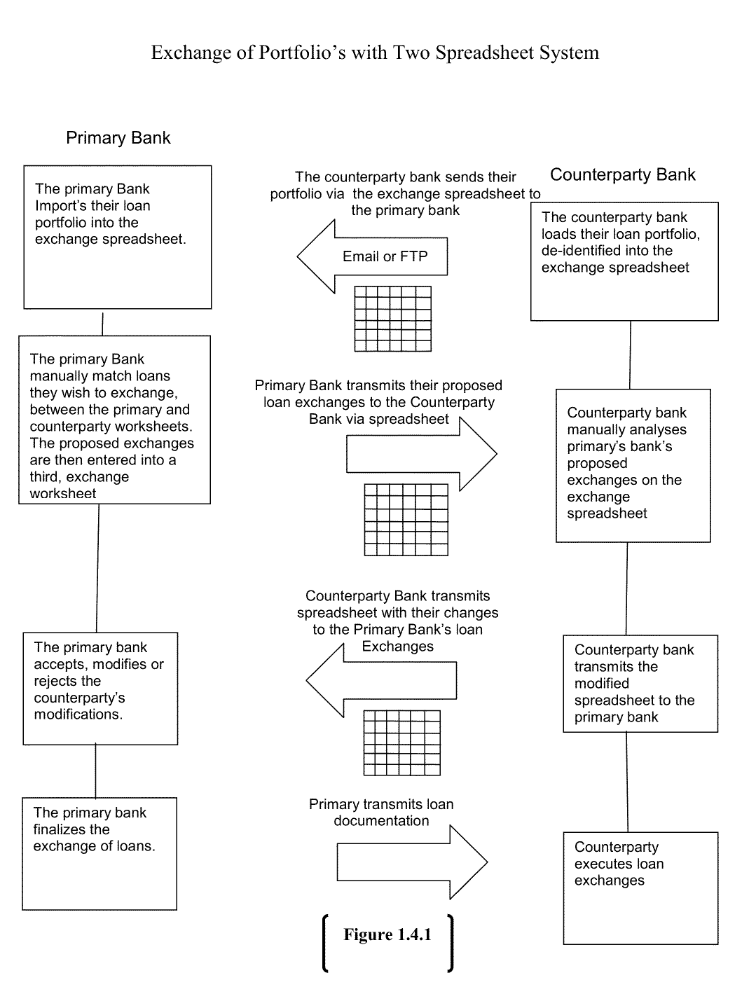

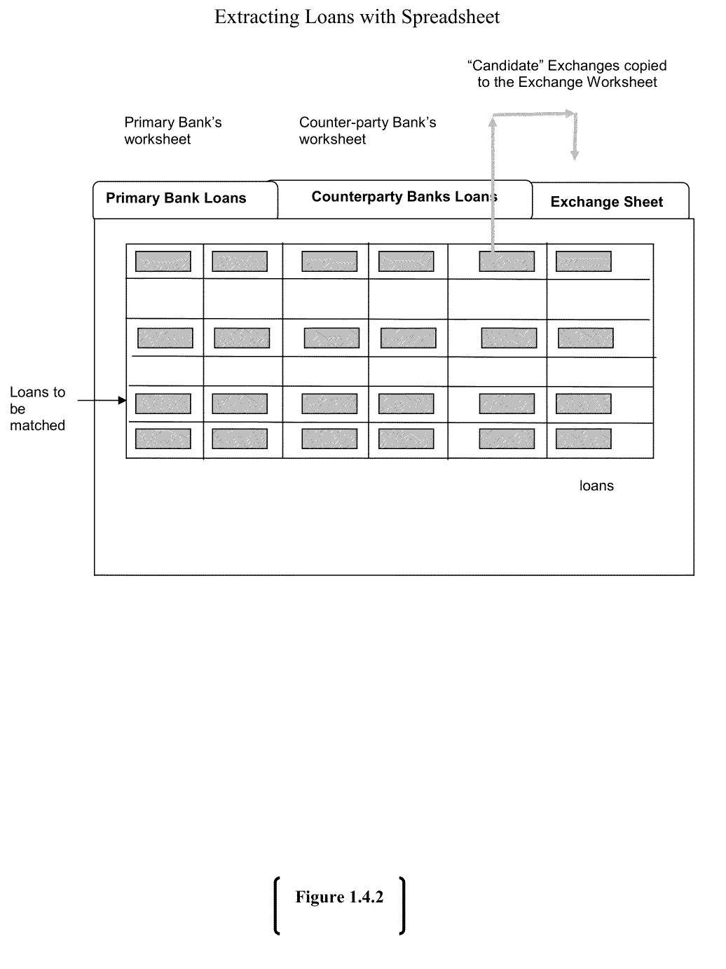

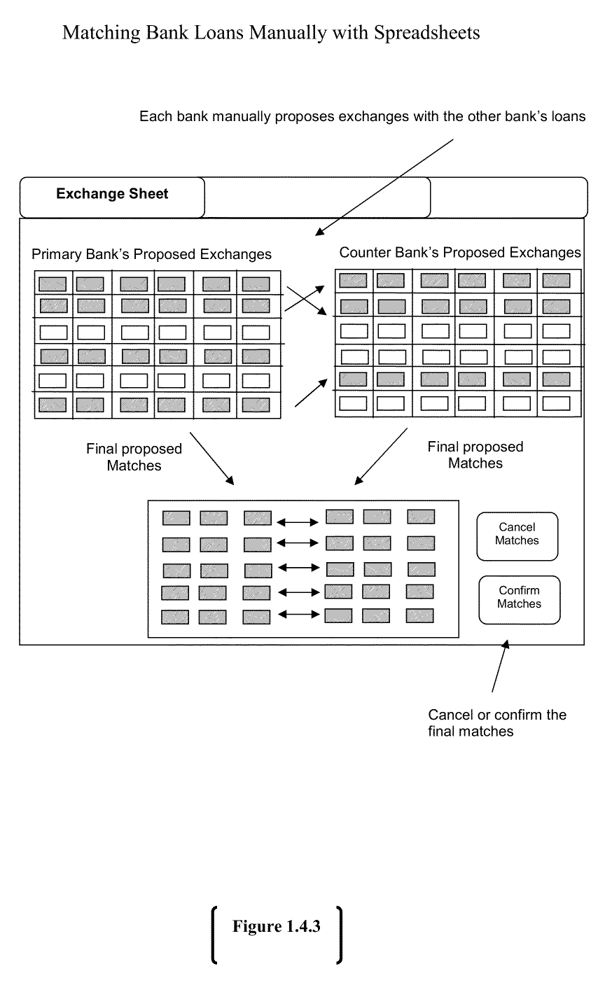

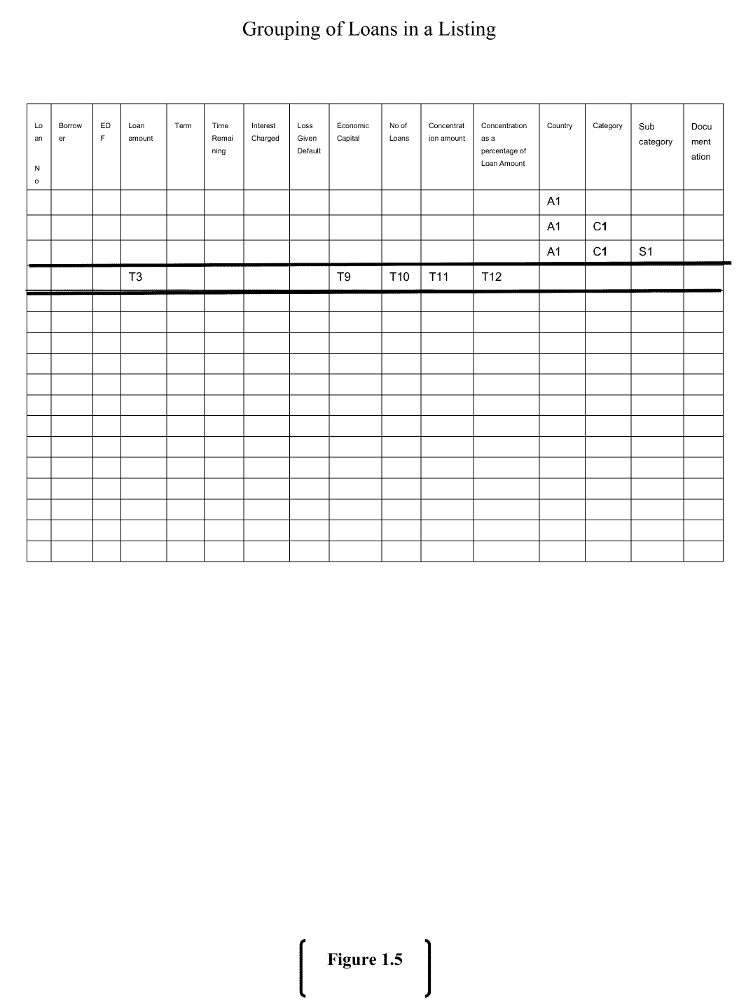

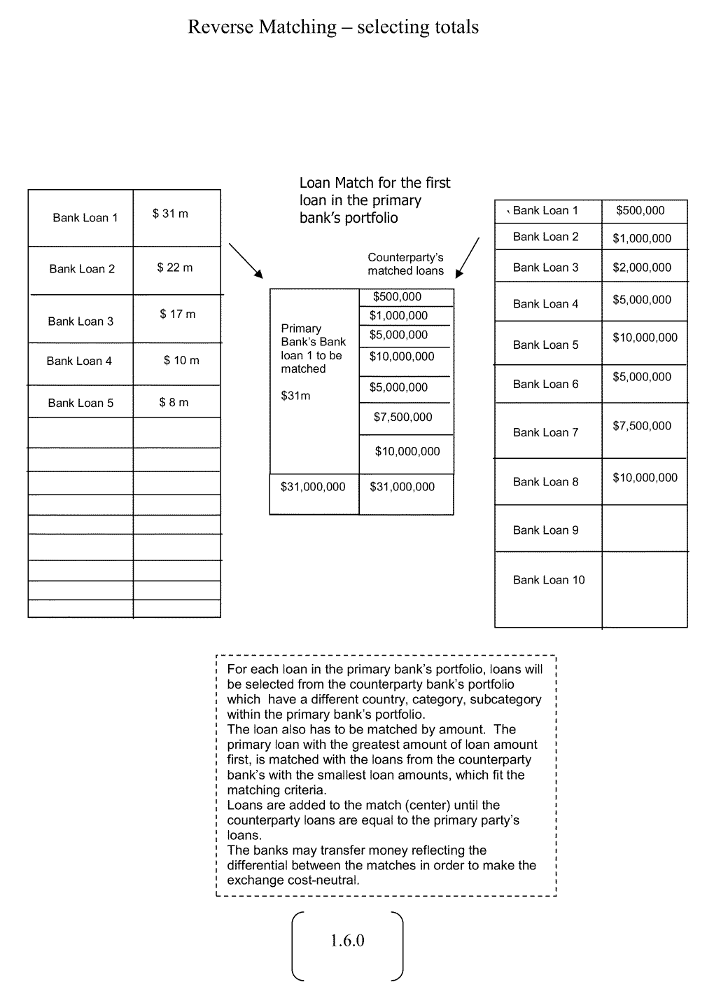

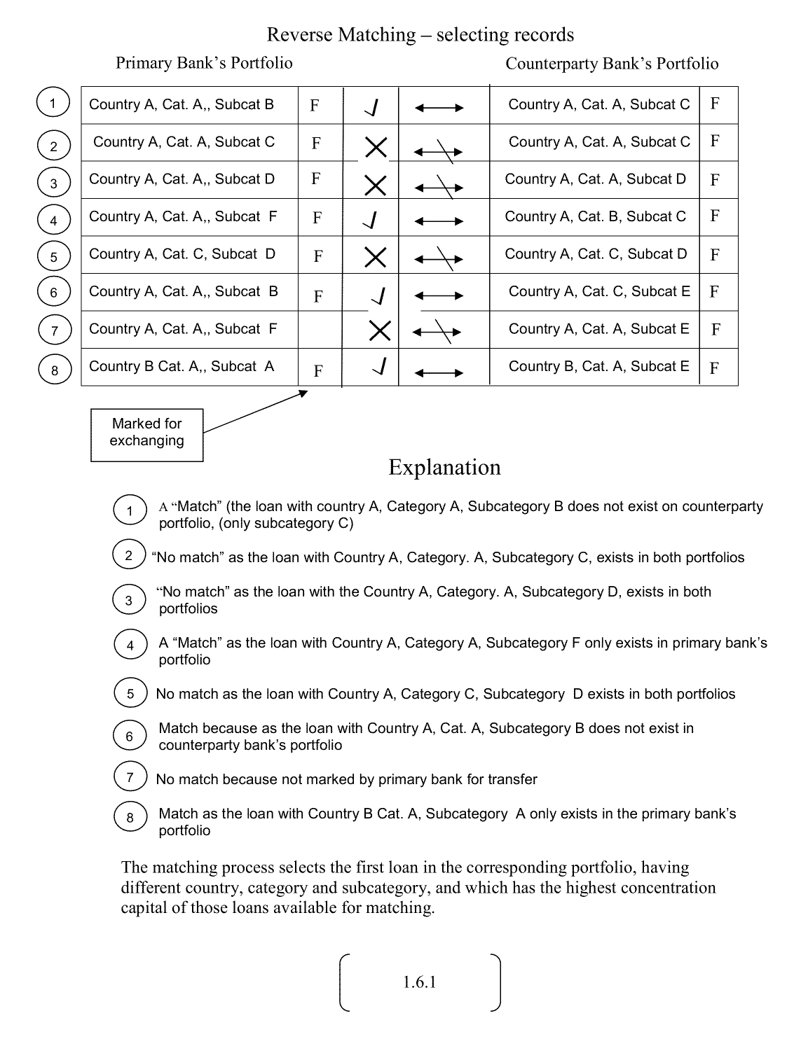

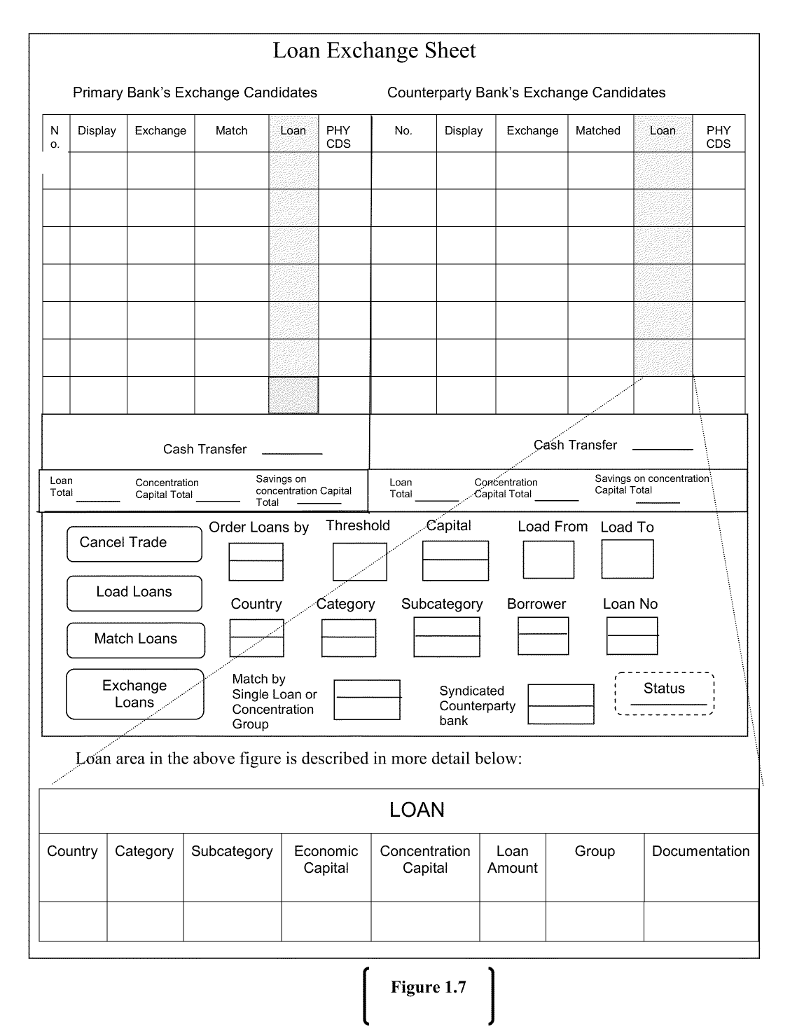

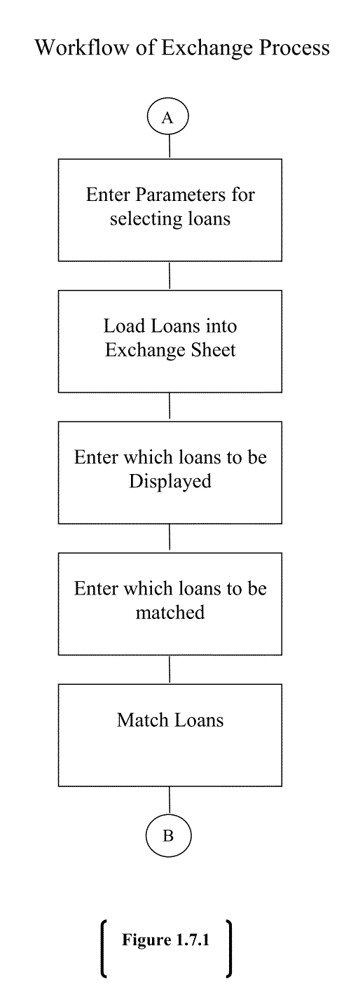

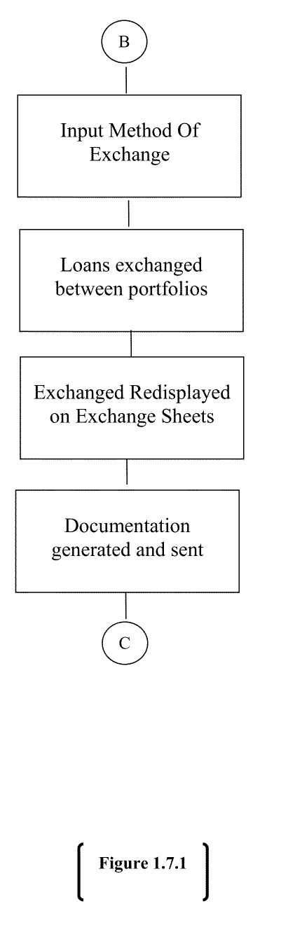

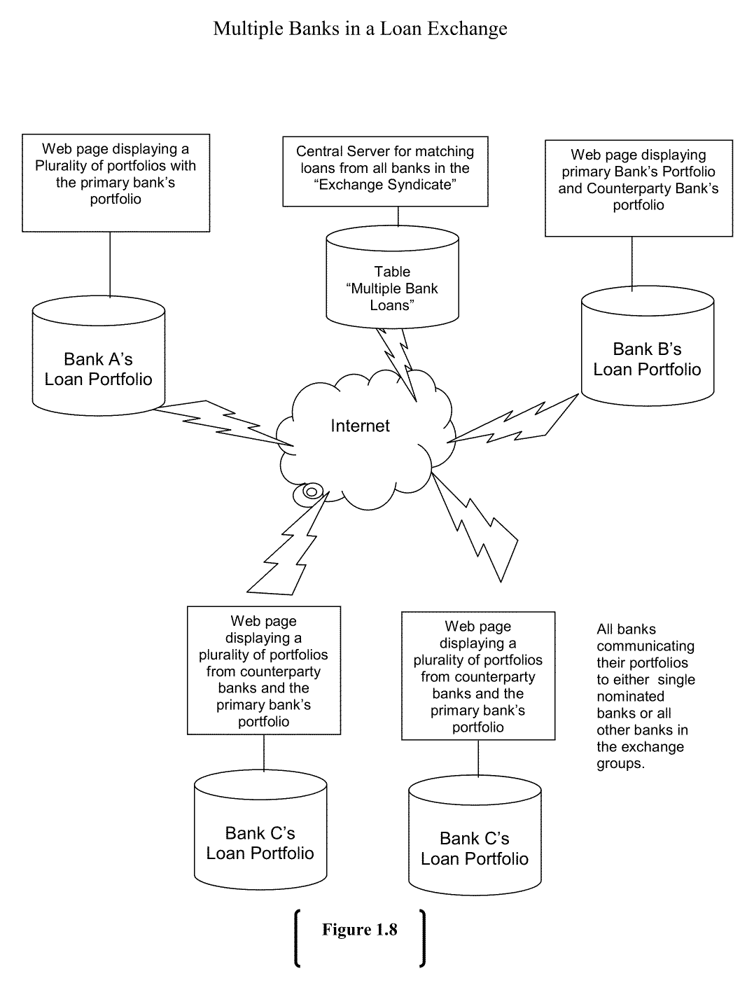

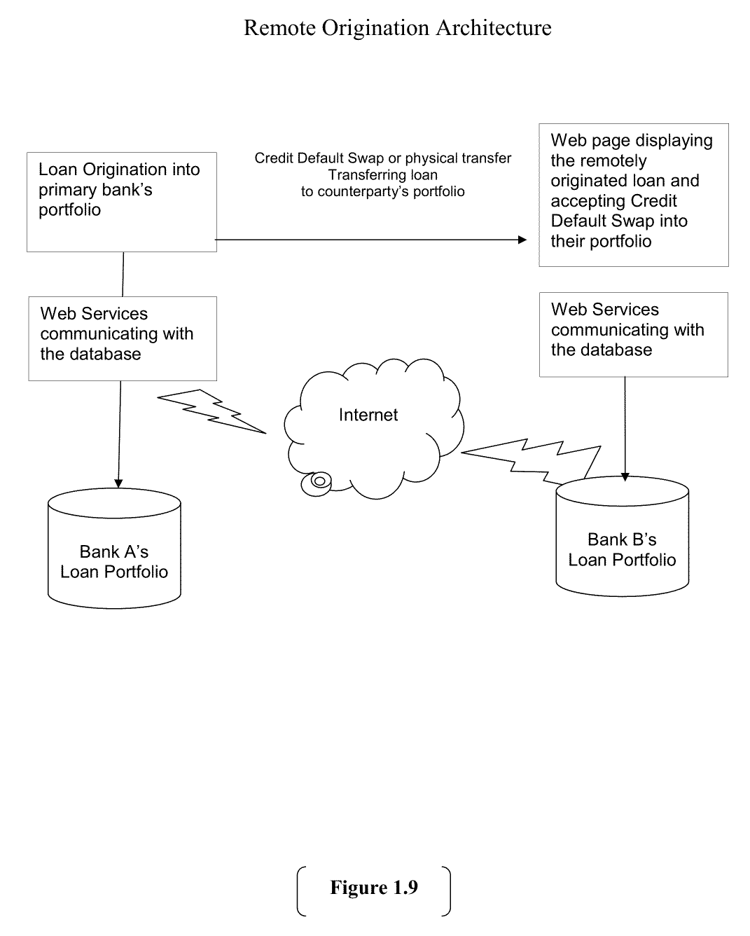

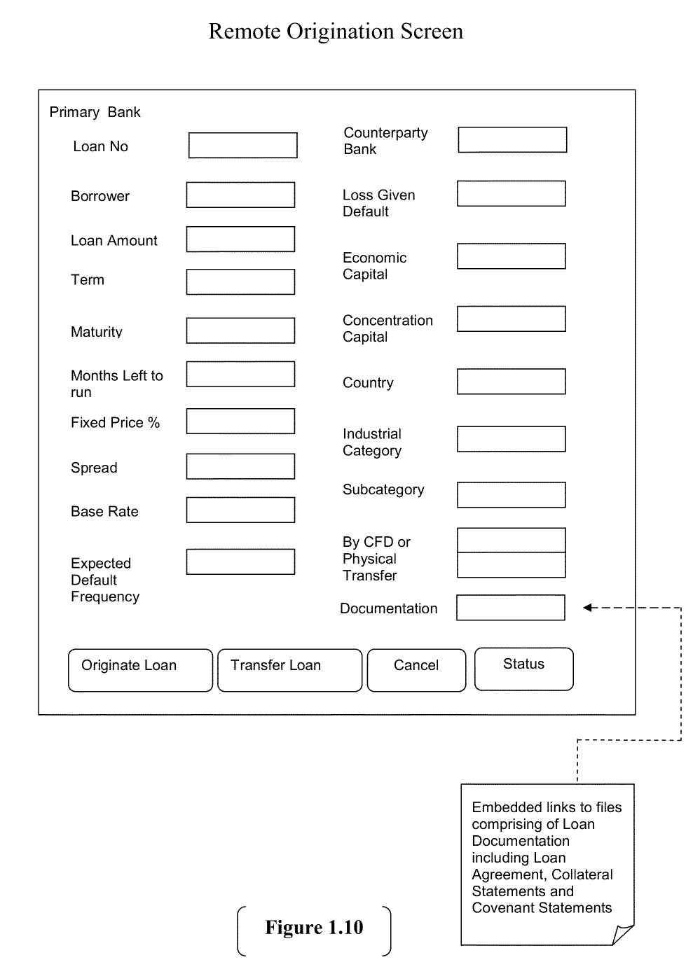

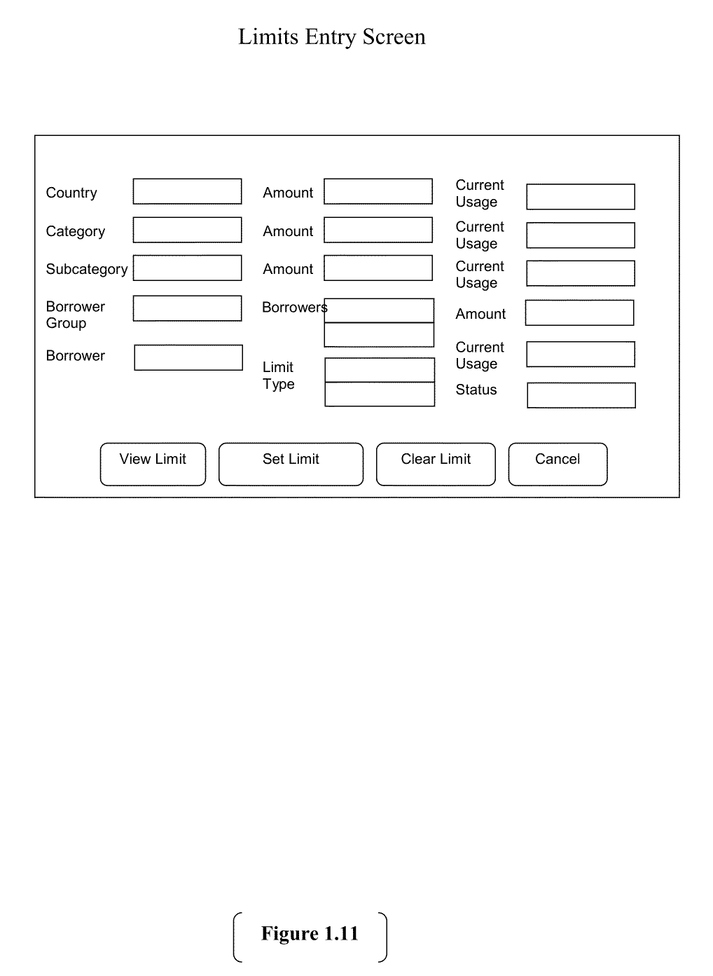

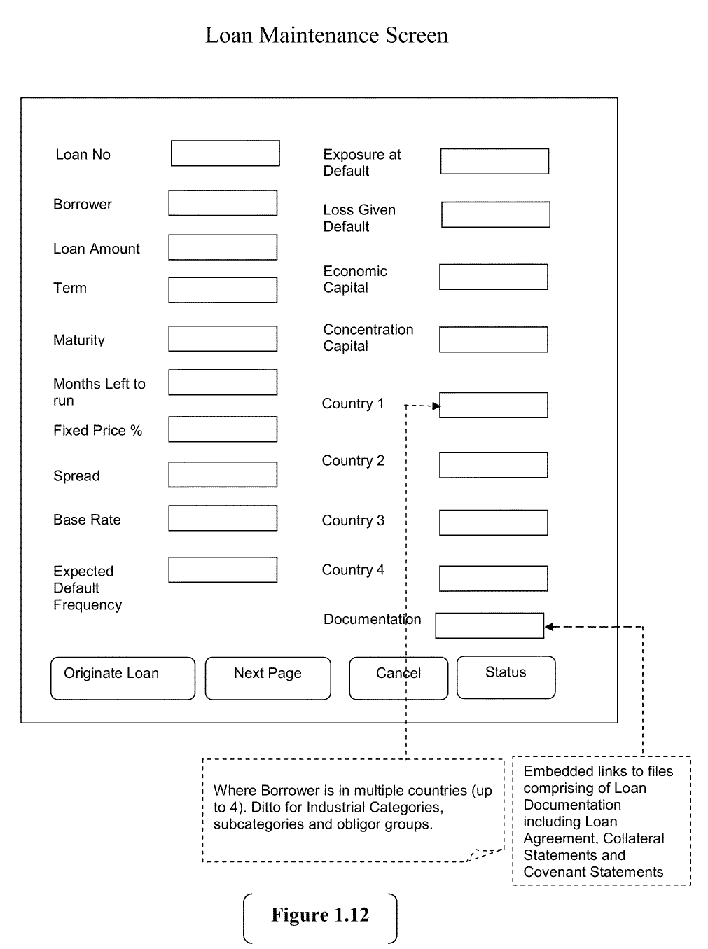

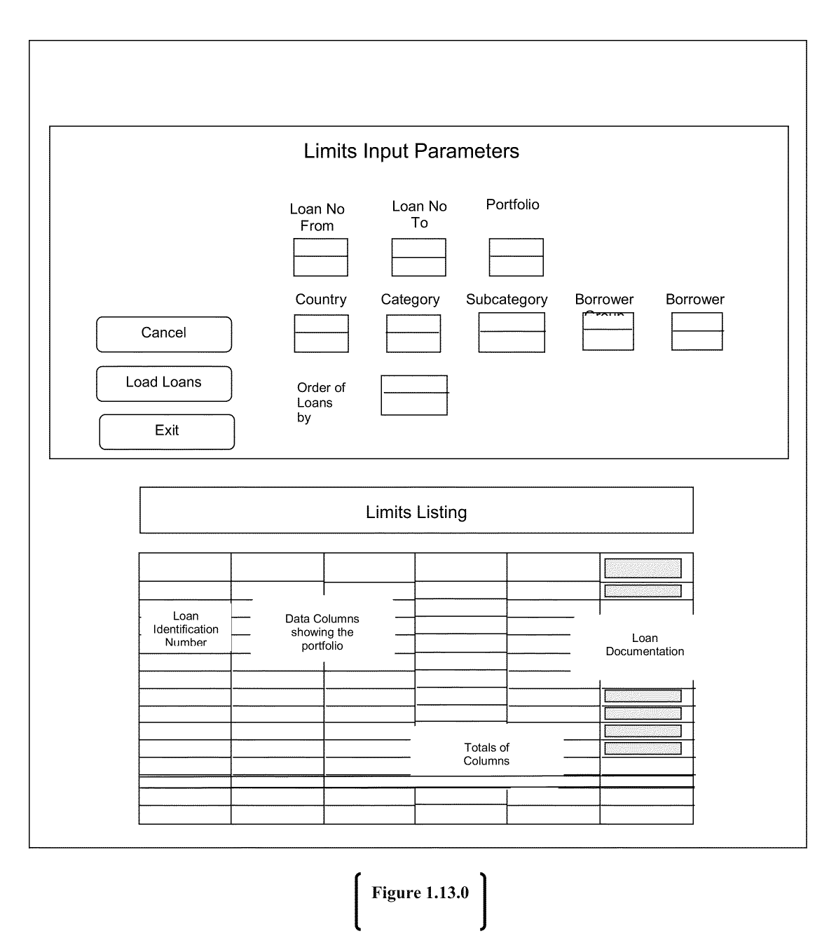

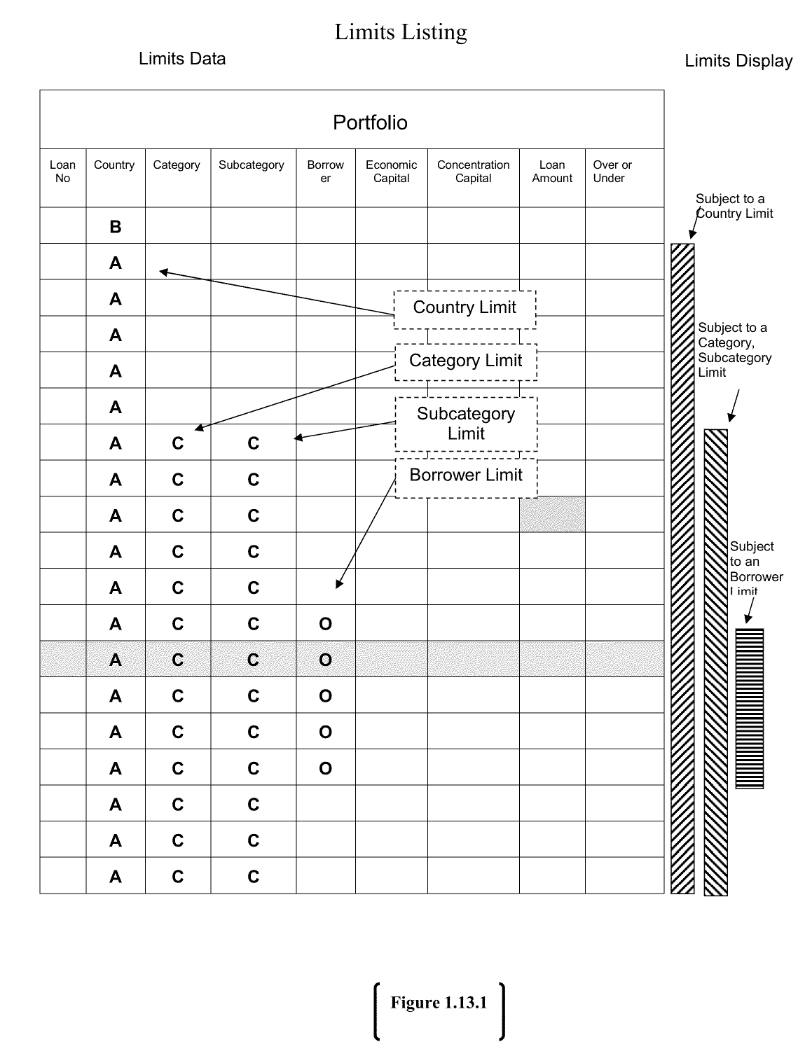

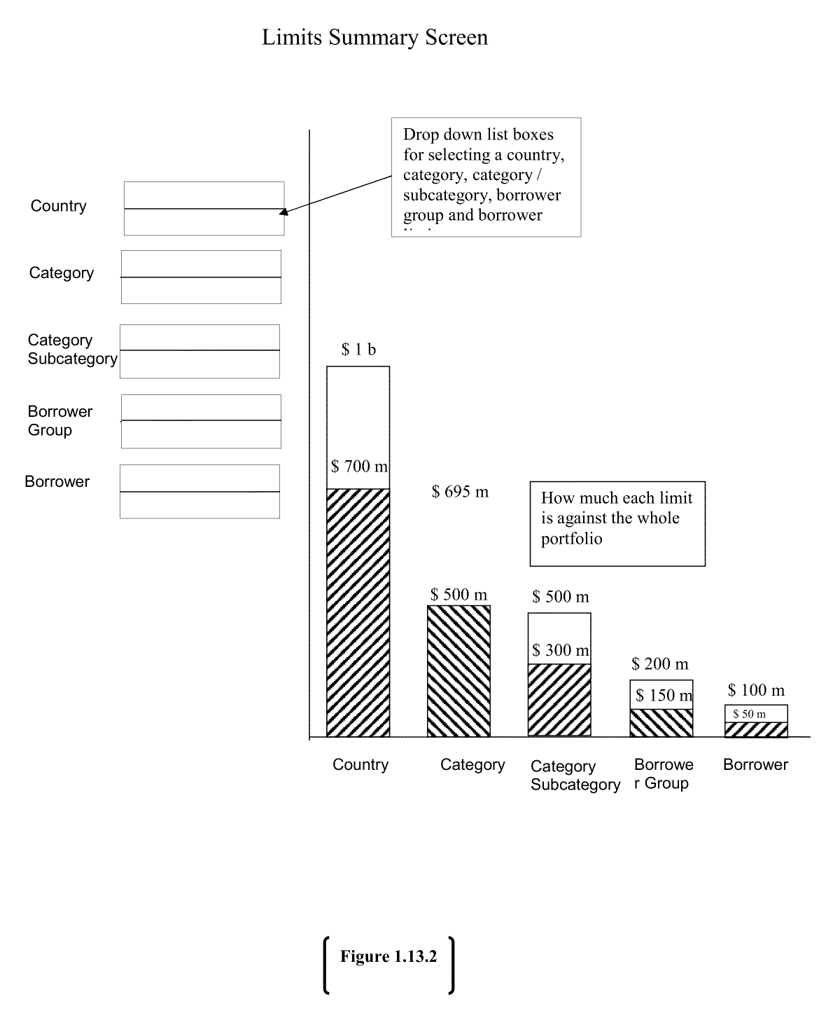

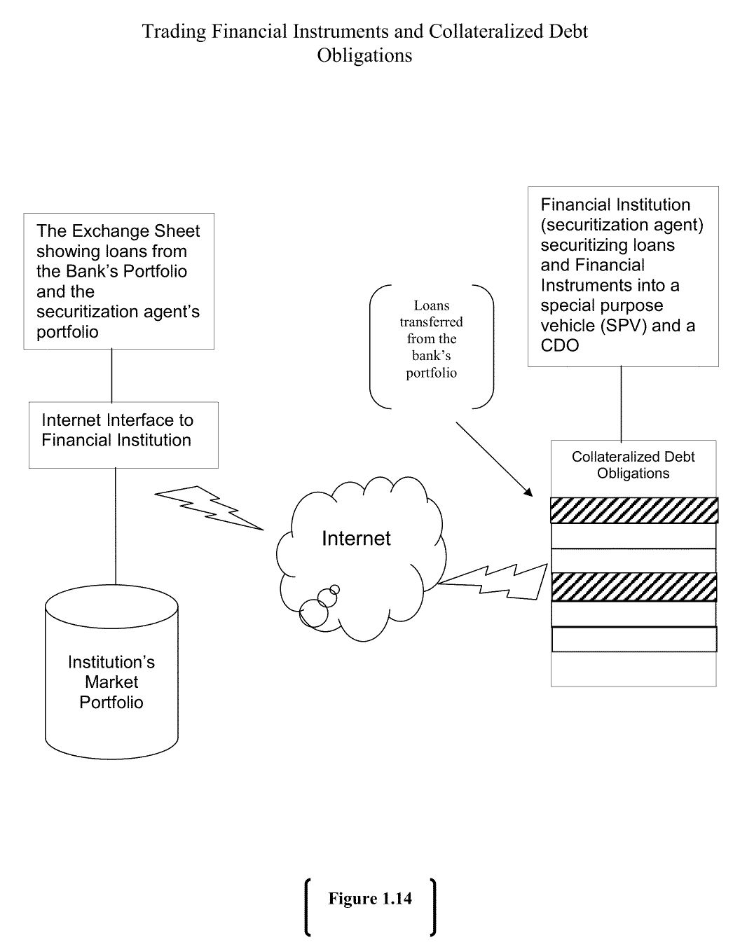

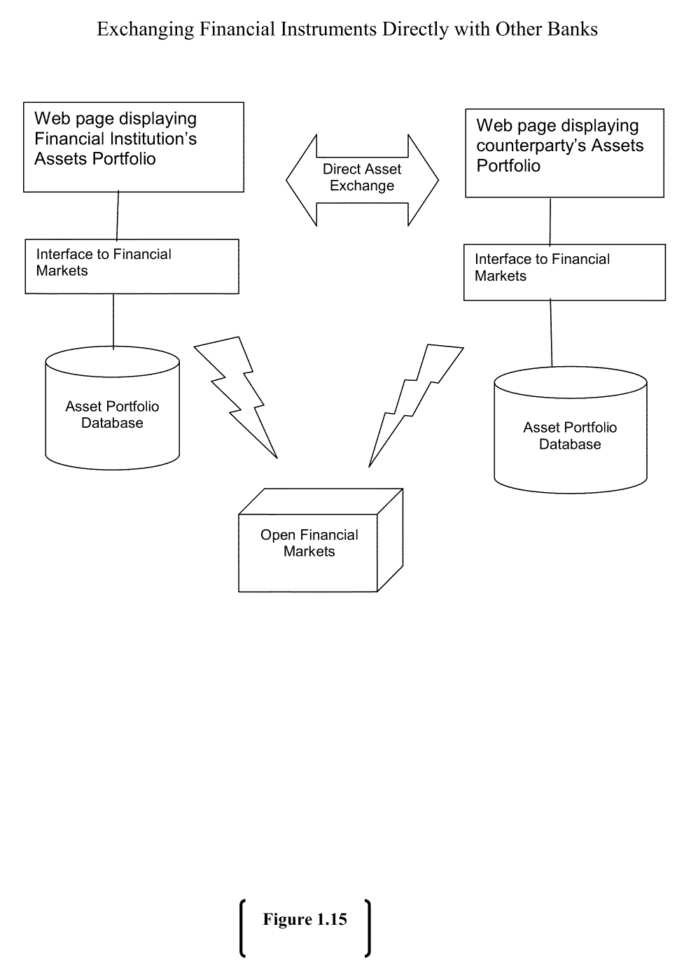

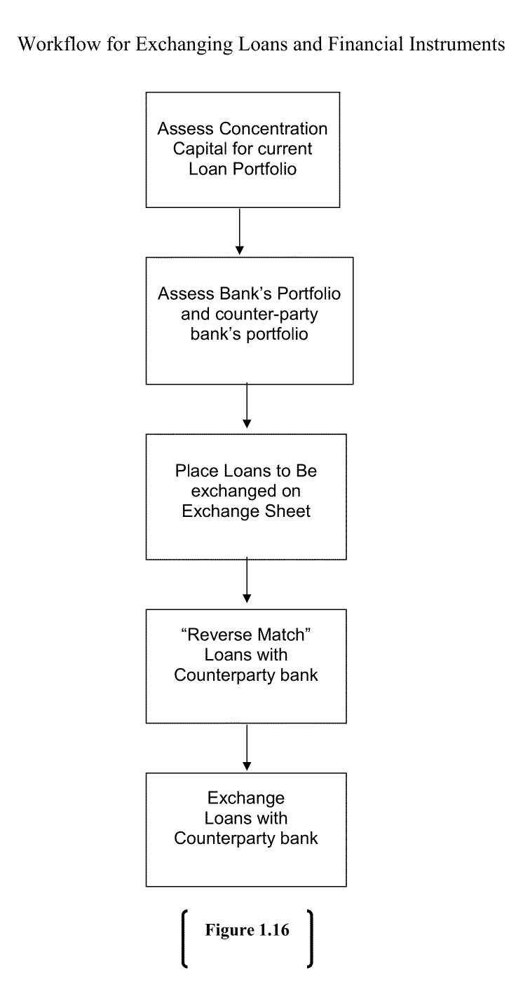

The present invention also allows the calculation and generation of the optimum combination of specific loan exchanges, between the two bank portfolios, and called “reverse matching”, which would have the greatest diversifying effect on both portfolios. Loans may be exchanged singly or in groups and may occur within two banks portfolios known as a “bilateral exchange” or more than two banks, known as an “multi-lateral exchange” or using an “exchange syndicate” see FIG. 1.8. The banks also have the option of paying an amount money for any loans which are not matched with a corresponding loan in the counterparty's portfolio, making the exchange “cost neutral” for both parties. Loans are exchanged by three methods.

The first is an outright “physical exchange” of the loans with the counterparty bank which transfers the ownership, rights and all aspects of the loan.

The next is “Credit Default Swap,” which is an agreement between the banks is to swap just the risk of default, the payment of interest and the repayment of the loan's capital, to the counterparty bank, but at the same time to keep the loan and its ownership on the originating bank's books. The present invention also allows for both types of loan exchange. It can also be seen as a bank taking out “insurance” on the loan with the counterparty bank guaranteeing the primary bank, for the risk of the loan's default, thereby removing its effects on concentration capital and credit limits on the primary bank's portfolio.

The third method of exchanging loans is where one bank cannot originate a loan to their client borrower. This may be because the first bank has reached a credit limit with that particular client, country or industry group. It also may be to avoid taking on the extra unwanted concentration capital associated with that loan. The present invention allows the primary bank to still originate the loan and keep their relationship with their client intact while at the same time transferring, to the counterparty bank, both the risk and cash flows (the interest and capital repayments) associated with the loan. This method is referred to as a “remote origination” (see FIG. 1.10). In remote origination, the primary bank, after originating a loan, then immediately transfers the loan, before being added to their own portfolio, including its risk and cash flows, to the counterparty's portfolio (with the counterparty's prior agreement), by either transfer methods described above (physical exchange or credit default swap), thus avoiding both the concentration capital and any credit limit on their portfolio that may otherwise be breached. The transfer of the loan can be by physical or by credit default swap outlined above.

The present invention also allows the bank to transfer its loans, instead of to other banks, to a Collateralized Debt Obligation or “CDO” which is a security made up of a plurality of loans transferred to a separate corporate legal entity called a “Special Purpose Vehicle”. Portions of the CDO are then sold to investors who in return may receive a higher interest rate than currently available on the fixed income markets.

The present invention allows the calculation of the best loans to move into the CDO and their rapid transfer from the bank's portfolio to the CDO.

Using the present invention, this capability could give rise to a means of generating a plurality of new CDO's populated with bank loans, in a process that could be termed a “debt securitization vehicle” or “CDO Factory”.

The result of the present invention and the diversifying of the bank's portfolio is twofold. It protects the bank from the chance of “systemic event” or large scale event in the global system that can threaten the financial stability of the bank or at least result in it taking disproportionate losses to those which would have accrued had the portfolio been already diversified.

It also reduces the total concentration capital the banks need to support the loan concentrations in their own portfolios which can be several percentage points of the value of the whole portfolio.

The result of the present invention will also result in more business flexibility, reduced costs in bank lending and improved responsiveness to the client's needs.

An additional result of invention will be the emergence of a liquid market in bank loans in a “clearing house” which services a plurality of banks are members of an exchange syndicate, described above. A “clearing house” is an organization which allows the buying and selling of financial instruments between trading partners and members of the exchange. These banks can then diversify their portfolios, by means of the current invention, by exchanging, buying and selling loans with all the other banks and CDO's which are also members of the clearing house.

The foregoing “Loan Exchange”, can be thought of as a clearing house and private market place for loans, with them being freely exchanged, bought and sold between participating banks in the loan exchange, and thereby gaining liquidity through loans being priced in the loan exchange.

### BRIEF DESCRIPTION OF THE DIAGRAMS

The diagrams of this invention are as follows:

1.0.0 “Technical Architecture—User Interface”—displays the communications of the screens, the computer server and database.

1.0.1 “Technical Communications Architecture”—shows how Web pages communicate over the Internet with both banks

1.0.2 “Software Architecture”—shows the software in layers from the web pages to the database. Each software layer communicates with the layer below it using task-to-task communication such as function calls and stored procedures. The top layer communicates with the user and the lowest layers with the database.

1.1.0 “Programming Modules (1)”. The diagram shows from left to right, the inputs, process and outputs of the main programming module, the Exchange Engine. The inputs include the user interface, the Loan Portfolio database and calculation algorithms. The outputs of the main module include updates to the database, the screen for matching of loans from the bank's database and the physical exchanging of loans with the counterparty's database. The main module is shown further broken down into the first two sub-modules of the main module, Portfolio Loading Module and the Concentration Capital Calculation module. The sub-modules are called from the main module and again show their individual inputs, process and outputs. These are the first two sub-modules of the six which comprise the main module.

1.1.1 “Programming Modules (2)”—Further details of sub-modules of the main programming module. The main module is broken down into a further two sub-modules which include the Exchange Matching Module and the Loan Exchange Modules, also called by the main module. The sub-modules are shown with the inputs, process and outputs

1.1.2 “Programming Modules (3)” Further details of the last two sub-modules called from the main module, including the Remote Origination module and the Credit Limits module. Again, the modules show their inputs, processes and outputs.

(1.1.0 to 1.1.2) Computer Program modules include inputs, process and outputs.

1.2.0 “Loan Listing”—shows the layout of the Bank's Loan Listing screen including the input parameters for the screen and listing area showing the bank's loans.

1.2.1 “Dual Loan Listing” displays a Web pages listing of loans from the primary bank's portfolio and counterparty bank's portfolio together in one screen. Input with the same parameters as in 1.2.0 the Loan Listing screen, the Dual Loan Listing screen is used to view the loan listing for both bank's portfolios for the purpose of identifying potential matches.

1.3.0 “Matching Data with Two Web-based Systems”. Both banks use the Web based system to match and exchange loans over the internet.

1.3.1 “Matching Data with a Single Web-based system”—shows the process communications used in exchanging loan portfolios between two banks, one bank the “primary bank”, using their internet based system and the other bank, the “counterparty bank”, using a spreadsheet (such as Microsoft's Excel) for transmitting the loans instead of the internet based system and database. The counterparty extracts matched loans into a spreadsheet and transmits the spreadsheet to the primary bank. The primary bank then reviews the matches from the spreadsheet and transmits their choice of loans for exchanging to the counterparty bank. The two banks then exchange loans updating the loan portfolio in the primary bank's database and the counterparty's spreadsheet.

1.3.2 “Exchange of Portfolio's with a Two Spreadsheet System”—is the same as the diagram 1.3.1 except in this diagram both banks are using spreadsheets to exchange loans between them.

1.4.0 “Extracting Loans with Spreadsheets” shows the process by which banks can match loans manually using spreadsheets, in the selection process. The primary bank's loans are in the first worksheet in the spreadsheet, the counterparty's loans are in the second worksheet and the loans which are to be exchanged are in the third worksheet. Loans can be extracted from each bank's worksheet and moved to the Exchange Worksheet.

1.4.1 “Matching Bank Loans Manually with Spreadsheets” shows the manual matching process in the Exchange Worksheet (in FIG. 1.4.0), using only spreadsheets (i.e. no web screen involved). Loans are extracted from the bank's and counterparty bank's worksheets into a separate Exchange spreadsheet (e.g. using Microsoft's Excel) shown in the FIG. 1.4.1. Matches are made by both banks by entering the loan numbers they wish to exchange. The matches are then listed in the exchange area below where they can be accepted or rejected by each corresponding bank

1.5 “Grouping of Loans in a Listing”—a listing of loans showing grouping by country, category and subcategory with totals. A1, C1 and S1 are Countries, Industry Categories and Subcategories listed hierarchically, with category within country and sub-category within category within country. T3 to T12 are totals for those columns.

1.6.0 “Reverse matching—selecting totals”—showing the process of sorting the two bank's portfolios for matching and exchanging. For each loan in the primary bank's portfolio, loans will be selected from the counterparty bank's portfolio which have a different country, category, subcategory within the primary bank's portfolio.
The loan also has to be matched by amount. The primary loan with the greatest amount of loan amount first, is matched with the loans from the counterparty bank's with the smallest loan amounts first, which fit the matching criteria. Loans are added to the match (center) until the counterparty loans are equal to the primary party's loans.
The banks may transfer money reflecting the differential between the matches in order to make the exchange cost-neutral.

1.6.1 “Reverse Matching process—selecting records”—showing the automatic reverse matching process, which matches loans with other loans in a counterparty portfolio, having a different country, category and subcategory groupings and having the highest available concentration capital.

1.7.0 “Loan Exchange Sheet”—showing the Exchange Sheet used by the banks to finalize loan exchanges between the banks

1.7.1 “Workflow of Exchange Process”—showing the workflow of the loan matching process.

1.8 “Multiple Banks in a Loan Exchange”—the exchanging of loans between a plurality of participating banks

1.9 “Remote Origination Architecture”—showing the component architecture of how a bank can originate a loan which is automatically transferred to the counterparty bank's portfolio.

1.10 “Remote Origination Screen”—showing the screen used to originate loans remotely into a counterparty bank's portfolio.

1.11 “Limits Screen”—screen for placing limits on a country, category, subcategory, group of borrowers and a single borrower and showing current usages

1.12 “Origination Screen”—showing the screen used to originate loans to be held in the bank's own portfolio

1.13.0 “Limits Monitoring Parameters”—showing the entry of retrieval parameters for the listing of limits.

1.13.1 “Limits Monitoring Listing” showing a listing of the bank's portfolio with the application and display of credit limits, for a country, a category, a category with subcategory, a group of borrowers and for a single borrower.

1.13.2 “Limits Summary” screen showing the limits and their usage for each country, category, subcategory, borrower group and borrower.

1.14. “Trading Financial Instruments Collateralized Debt Obligations”—exchanging loans into a collateralized debt obligation (CDO) which is an investment vehicle made up of loans and other financial instruments.

1.15 “Exchanging Financial Instruments Directly with Other Banks”—showing banks exchanging loans with each other directly as well as through open trading markets.

1.16 “Workflow of a Loan Exchang—the key steps of exchanging band

### DETAILED DESCRIPTION

The present invention comprises of two or more PC computers situated at a plurality of banks One of the banks is referred to as the “primary bank” and the other the “counter-party bank” with which the primary bank wants to do business.

The present invention consists of a computer system comprising of internet web pages which are in a web browser, and a database of data comprising of each bank's loans. See FIG. 1.0.0.

The computer system also comprises of “web services” which runs on a system server connected both to the web pages and the database.

A database is part of a computer system for storing and retrieving data tables housed on magnetic read-write media. The present database contains the details of their clients and their portfolio of loans. The present invention can be used for a wide variety of financial assets including but not limited to, Institutional, Corporate and Real Estate portfolios of loans. Corporate borrowers are corporations up to a certain size designated by the bank and Institutional borrower are larger, mostly public corporations, other banks and sovereign debt (that is countries).

In another embodiment of the invention the system performs the same function as for the institutional loan portfolio but for loans comprising of:
a. Loan portfolios of corporations which are not institutional;
b. Loan portfolios of smaller medium enterprises (“S.M.E.”s];
c. Loan portfolios comprising of real estate loans and mortgages and
d. Loan portfolios comprising of consumer loans.

The present invention requires the following hardware and communications components (see FIG. 1.0.1):
a. a computer processor;
b. computer readable memory operatively connected to the processor, the computer readable memory comprising computer code adapted to provide the functions in the foregoing description;
c. a computer display connected to the processor or other common connection to the processor;
d. a magnetic device containing a relational database (such as SQL Server from Microsoft) tables and data for the invention in machine readable form;
e. A communications connection to the internet;
f. A communications connection to open trading markets via proprietary feeds as required by the system (see FIGS. 1.0.0 and 1.0.1);
The present invention requires a number of computer software programs (see FIG. 1.0.2) which provide:
   a. web pages in a web programming environment (such as the language C# and software web environment such as ASP .NET from Microsoft) for manipulating and displaying on the internet computer spreadsheets (such as Microsoft Excel);
   b. display of computer screens and inputs by means of Web Pages (such as HTML);
   c. display of computer screens and also inputs and outputs by means of a spreadsheet display and the spreadsheet being interfaced directly to the database by means of a language (such as Visual Basic from Microsoft) and a database interface between the spreadsheets and the database (such as OD BC from Microsoft) and
   d. the relational database (such as SQL Server from Microsoft or Oracle from Oracle), a software component for storing tables including “stored procedures” with which to store and retrieve the data from the relational database;
   the foregoing being described in a “Technical Communications Architecture” shown in FIG. 1.0.1. The Exchange Process is a software component comprising of, but not limited to, the following software sub-components:
      1. a Portfolio Loading Module for loading loans into a portfolio database;
         a. a Concentration Capital Calculation module (see below); for calculation of concentration risk capital
      2. An Exchange Matching Module below for the calculation of loans which are candidates for exchanging between the two portfolios;
         a.
      3. A Loan Exchanging Module (see below) for the physical exchanging of loans.
      4. Remote Origination module for allowing banks to originate loans into another bank's portfolio by remote origination (see below)
      5. A Credit Limits module for inputting and setting credit limits for:
         a. Countries;
         b. Industry category;
         c. Industry sub-category;
         d. Borrower group and
         e. Borrower

The component architecture for the above system is in FIGS. 1.1.0, 1.1.1 and 1.1.2

The database subcomponent is made up of tables, which are areas of the computer systems disk drive which is machine readable and writeable, to store data about the loan portfolio.

The “Loan Data Table” reflects the loans stored within the database contain the following fields:
1. Loan number—a unique number within a participating bank for identifying a loan (n.b. Database's primary key);
2. Bank Name; Borrower (company);
3. Loan Amount (in millions);
4. Term (months);
5. Maturity Weighting fact (time left to run);
6. Fixed price interest;
7. Spread interest;
8. Benchmark Rate;
9. Expected Default Frequency;
10. Loss Given Default (how much would lost, counting collateral);
11. Economic Capital (derived from on a number of vales on most aspects of the loan);
12. Economic Capital as a Proportion of the portfolio's Total economic capital;
13. Concentration Capital Amount to be set aside for each loan to address the loan's concentration risk;
14. Number of Loans grouped by Country, Category and sub-category;
15. The loan's Concentration Capital as Percentage of the Loan Amount;
16. Country Category Sub Category (concatenated);
17. Country;
18. Category;
19. Subcategory; Borrower Group;
20. Country, Category and sub category (concatenated);
21. Credit Limits for Country;
22. Credit Limits for Category and Subcategory;
23. Credit Limits for Borrower Group;
24. Credit Limits for Borrower;
25. Spreadsheet name used as a source to import loans into the database;
26. Spreadsheet Worksheet name;
27. Rows from (in Excel spreadsheet);
28. Rows to (in Excel spreadsheet);
29. for Display (“D” or “ ”);
30. for Matching (“M” or “ ”);
31. for exchange (“E” or “ ”);
32. Matched Loan Number in counterparty bank;
33. Exchanged Number in counterparty bank;
34. Remote Origination number;
35. Documentation of Loan;
36. Loan Status;
37. Syndicate Originating bank name;
38. Benchmark Type for Floating Rate Interest;
39. Matched Record indicator;
40. Displayed Record Indicator and
41. Exchanged Record Indicator.

The Loan Table is loaded from data derived from:
a. Data from other credit or portfolio systems;
b. Data from spreadsheets and
c. Data from external databases.

The data is loaded by a loading component which reads the loans in external read-write memory and external read write disk systems, by way of a computer module.

The result of the foregoing description and the technical architecture is that each bank can see both the portfolios, that of their counterparty bank and that of their own bank. For confidentiality purposes the present invention includes the “de-identifying” the names of borrowers of the loans before they are displayed to the counterparty bank. This includes changing the name of the borrower to be a unrecognizable string of letters but which can be made identifiable again with a computer function.

The borrower name should be unrecognizable to the counterparty bank for the privacy of the borrowers. The same is done for the counterparty's loans displayed to the primary bank. All other information apart from the de-identified field must be displayed in this embodiment of the system.

If there are two or more loans for one borrower, each loan will have its own record and the borrower name will be repeated in each loan.

“Loan Listing” can be used by both the primary and counterparty banks.1.2.0 is retrieval parameters for the loan listing. The input parameters can be used to retrieve both the primary and counterparty's loan listings. The “portfolio” option allows each banks to decide which portfolio to list. Using the web page, primary bank can scroll up and down to see their portfolio in detail including the loan documentation on the same web page. The two screens and portfolios within a Web page are represented by the FIGS. 1.2.0 and 1.2.1.

Loan documentation such as the Loan Agreement and Loan Covenants are kept in files on the server in formats such as, but not limited to, Word (by Microsoft) and a document viewer such as Postscript Data Format “PDF” (by Adobe) but not limited to any document format in particular.

By means of “object linking and embedding” (by Microsoft) the icon in the documentation column in FIG. 1.2.1. the system can store and retrieve the relevant documentation files from the file system associated with that loan record. Depressing the icon on the loan's line in the Portfolio Listing (see FIG. 1.2.1), or Exchange Sheet (see FIG. 1.7), will cause the document to automatically come up in word processors such as Word (from Microsoft), viewers such as PDF Viewer (from Adobe) or any other format by which the file is retained in the server. The user can both store files and retrieve them and there can be multiple icons in the documentation column signifying multiple documents for that loan.

The party in each bank also sees a “Loan Exchange Sheet” in FIG. 1.7, which contains all the loans to be exchanged between the primary and counterparty banks Each loan also displays a unique loan number, assigned to it by the present system, identifying each loan individually.

On depressing the “match loans” command button in FIG. 1.7 the following occurs. The system executes the “reverse matching” process outlined below.

In a further embodiment of the system, the following is the position of each bank. The primary bank has a web page and web based system as described above showing their own portfolio, but in this case the counterparty bank does not have access to the current invention running over the internet, see below in “Matching Data with a Single Web-based system” in FIG. 1.3. Instead, the counterparty bank extracts loan data from their own database, or other source, comprising of their loan data, into a spreadsheet (such as, but not limited to Microsoft Excel), known as the “Exchange Spreadsheet” which is based on the Loan table fields, see above.

The counterparty sends the primary bank an exchange spreadsheet, comprising of their loan data in the required format in an Spreadsheet.

The data from the exchange spreadsheet, is read in and imported into the primary bank's database, by means of an import program. The borrowers will normally already have been de-identified as explained below.

After the primary bank has imported the exchange spreadsheet into their database, the primary bank can then view the counterparty bank's data using the Loan Listing in FIGS. 1.2.0 and 1.2.1, and the Loan Exchange Sheet in FIG. 1.7, and the other web based screens of their system. The primary bank can then perform all the functions with respect to the counterparty bank's portfolio, including the “reverse matching” for the exchange of loans, as described below in of the first embodiment.

The counter party without the use of the internet based system is only able to match the loans manually by copying their proposed loans for exchange, to a special worksheet, known as the “Loan Exchange Sheet”, within the exchange spreadsheets.

The counterparty's proposed changes are re-imported into the primary bank's internet system and analyzed using the loan exchange sheet, FIG. 1.7. The process of extracting the loans, the counterparty analyzing the proposed exchanges, and the re-importing, may be repeated several times until there is a set of mutually agreeable exchanges.

In conclusion, the second embodiment allows a bank to use the present invention “unilaterally”, when the counterparty bank does not have the present invention described above.

The exchange of loans by the second embodiment is shown in “Matching Data with a Single Web-based system” see FIG. 1.3.

The third embodiment is where neither party has the use of the web page component of the present invention, that of using web pages only over the internet described above. Instead both party's portfolios are imported into a spreadsheet, called the “Exchange Spreadsheet”.

Within the exchange of spreadsheets, primary bank's loans are in one worksheet, “the primary worksheet”, and the counterparty bank's portfolio is in another worksheet, “the counterparty worksheet”. The loans displayed in the primary bank's screen belonging to the counterparty will be de-identified, and visa-versa with the primary bank's loans in the counterparty's screen, in order to stop either party from knowing the clients of the other party.

The primary bank will choose the loans from the primary worksheet that they wish to exchange with the counterparty. The primary bank will copy, the primary bank loans they wish to exchange, from the primary worksheet into a third worksheet, the “Loan Exchange worksheet”.

The counterparty bank will then also copy the loans that they wish to exchange with primary bank, into their worksheet. The architecture for this is illustrated in FIG. 1.4.1, “Exchange of Portfolio's with the Two Spreadsheet System” where both banks copy their loans they wish to exchange into a worksheet of an exchange spreadsheet, illustrated, in FIG. 1.4.2 “Extracting Loans with Spreadsheets”. The loans may be re-identified now to facilitate both the bank's deciding which loans they wish to exchange.

The two banks will match the loans to exchange in a way analogous to the reverse matching, see below, process including but not limited to, ordering the rows on the primary bank's sheet in descending order of loan amounts and ordering the rows in the counterparty bank's sheet in ascending order. Taking the first loan from the primary bank's list and finding a number of loans in the counterparty bank's list with:
1. different country, category, and subcategory and
2. loans totaling on or near to the primary bank's loan

The differential in the totals for each bank can be made up by a cash exchange by either party to ensure the exchange is otherwise cost neutral. The loans so matched can be then exchanged by a manual process including sending the relevant transfer information between the parties.

In a further embodiment of the system the loan data in the spreadsheets are also stored on a database. The data is extracted from and written back to tables in the database using a communications protocol between the spreadsheet and the database such as, but not limited to, Microsoft's “ODBC”.

In this way the key data from the spreadsheet cannot be copied or changed without updating and retrieving from the database as well, ensuring the integrity of the data at all times. It should be noted that without the communication to the database, copying and changing the spreadsheet data, can lead to a loss of accuracy and integrity with multiple copies of worksheets in operation at the same time and spreadsheets being dispersed among multiple computers. Storing of spreadsheet data in the database therefore ensures that the spreadsheet data has single source within a protected environment.

In addition to a database capturing the key data from the spreadsheet, using the communications link to the data, the database could also be used to initially populate, update and store the inputs to the spreadsheet, including the exchange matches by the parties, which have been updated on the exchange spreadsheet.

The banks can both now see the loans that the counterparty wishes to exchange on the exchange worksheet. The two banks can then perform matching as described above.

For the primary and counterparty banks with spreadsheets connected to their respective databases, the databases can then copy the loans for matching to the primary bank's and the counterparty bank's areas in their exchange sheets, into a lower area in worksheet, called the “exchange area” comprising of the proposed final matches. See FIG. 1.4.3 “Matching Bank Loans Manually with Spreadsheets”.

The exchange spreadsheet is passed between primary and counterparty banks to modify and finalize the proposed exchanges in the exchange spreadsheet and the exchange worksheet.

The loan's Exchange Worksheet are the matches that have been agreed upon in the manual spreadsheet matching process.

When the trades between the primary and counterparty banks, are finalized each bank re-identifies their loans on the Exchange Worksheet only, resulting in each bank knowing the names of the borrowers to be exchanged in the corresponding bank.

This re-identification process may trigger a further round of modifications and transfers between the banks

In conclusion, the third embodiment, allows the parties to use the invention “off line” to each other, that is without the use of the web based systems, or internet communication, as in the first embodiment.

The technical architecture of the third embodiment and for exchanging loans via this mechanism, is shown in FIGS. 1.3, 1.4.1, 1.4.2 and 1.4.3.

The borrowers and their loans are grouped by country, industry group, industry and sub-category. Loans can vary in size, but are normally loans between one million dollars and hundreds of millions of dollars, either made available by the bank on its own or in a syndicated loan (loan syndicated and originated by several banks with the primary bank).

The size of the loan in conjunction with the size of the grouping of which it is a member, determines its concentration capital. The larger the grouping, the higher the concentration capital is likely to be. The calculation of loan concentration capital is described below.

For the purposes of the diagram in 1.5 “Grouping of Loans in a Listing”, the groupings are represented by a letter and a number, for countries, categories and subcategories. Heavy lines denote totals for that group.

Each group can be from single loan to a group comprising of a number of loans, the later representing a higher portfolio concentration risk.

The bank can see the portfolios in one of three ways.

The first way is listing all loans in detail: Displaying all the loans in detail showing the fields below:
1. Loan No. (a unique identifier assigned to each loan in the system); Borrower (company, bank or sovereign borrower);
2. Expected Default frequency or Borrower rating (“EDF”);
3. Loan amount (in millions of dollars);
4. Term of the loan in months to maturity;
5. Time remaining in months;
6. Interest charge in two forms:
   a. Fixed interest charged at regular intervals;
   b. Variable interest charge as a “spread” over an agreed variable interest or “benchmark rate” and the agreed benchmark rate type (such as Federal Funds Rate or Treasury Bill Rate).
7. Loss Given Default or loss assumed by the recovery of collateral;
8. Economic Capital for the loan;
9. Number of Loans;
10. Number of Loans in this group;
11. Concentration capital for the loan as calculated below;
12. The loan's concentration capital as a percentage of the loan's amount; Countries of loan (the loan originated in up to 4 countries);
13. Categories of loan;
14. Sub-Categories of loan.
15. Documentation for the loan in either Microsoft Word or PDF file from Adobe. Clicking on the line at this field will open the loan documentation which contains all the loan agreement, covenants of the loan, and collateral statement.

All loans in the primary bank's portfolio are de-identified when displayed in the:
1. counter party's Loan List (FIGS. 1.2.0 and 1.2.1);
2. Grouping of loans listing (FIGS. 1.5) and
3. the Exchange Sheet (1.7);

The counterparty's loans are similarly de-identified to the primary bank. De-identifying is done by a changing the borrower's name to a random string which can be changed back. De-identification is to maintain for both bank's confidentiality of borrowers and the confidential details of the both bank's business. After the banks have communicated and displayed their loans de-identified, they can re-identify them, as described below, so that they are fully disclosed to the other party.

The loan portfolio, displayed in the first way described above (listing all the loans in detail), is shown in FIG. 1.5.

The loan portfolio, displayed in the first way described above (listing all the loans in detail), is shown in FIG. 1.5.

Loans occupy one line per loan as in the FIG. 1.5 above.

Loans are grouped in three ways, shown in FIG. 1.5:
1. By country (as for lines comprising of “A1” in FIG. 1.5);
2. By Category (as for “C1” in FIGS. 1.5) and
3. By Country, Category and subcategory (as for “S1” in FIG. 1.5).

Total lines appear for (a) each country, (b) for each category and (c) for each subcategory. Totals appear for the following columns:
1. Loan amount;
2. Economic capital;
3. Number of loans;
4. Concentration Capital amount and
5. Concentration Capital as a percentage of the loans (as for “T3”, “T9”, “T10”, “T11” and “T12” in FIG. 1.5)

The following fields are displayed on the web page as shown in FIG. 1.5: Loan No
1. Borrower name;
2. EDF (Risk Rating)
3. Loan amount;
4. Term in months;
5. Months left to run;
6. Interest charge—Fixed price interest;
7. Interest charge—Floating rate interest (a “spread” as a margin over an agreed market rate);
8. Benchmark Type (such as “REPO” or “LIBOR”);
9. Benchmark rate to add to the Floating Rate interest;
10. Expected default frequency (EDF), as a measure of the likelihood of default by borrower;
11. Loss given default (LGD), as a measure of the likely recovery rate of collateral and
12. Economic capital (EC), as a measure of the capital to be kept against this loan for standalone risk.

The following additional columns can be displayed on the two Web pages making up the Loan Origination Screen:
1. Loan No
2. Borrower
3. Loan Amount
4. Term
5. Maturity
6. Months left to runFixed Price RateSpread over
7. Benchmark
8. Base Rate (which bench rate to use for spread)
9. Expected Default Frequency
10. Limit Type—type of limit
11. Limit Amount
12. Exposure at default (EAD) or how much money would be left owing at a default;
13. Proportion of economic capital for this loan divided by the total economic capital for this grouping of loans;
14. Proportion of economic capital of this loan to the economic capital of the whole portfolio;
15. Concentration Capital required to offset the risk from concentration from the individual loans in this group;
16. Concentration Capital over the each loan amount, expressed as a percentage;
17. Total Concentration Capital for this (Category plus Sub-category) over total concentration amount for the whole portfolio;
18. Country;
19. Category;
20. Subcategory and
21. Documentation button.

The concentration capital risk (additional to economic capital), will offset each loan's risk of default due to its concentration within a country, category and sub category. The grouping of the listing is either by country or country plus category or country plus category plus sub-category.

It must be noted that the concentration capital is higher per loan, for loans in larger groupings because these loans are more vulnerable to the default risk of their whole group, such as a country or an industry. Loans in smaller groups have proportionately less concentration capital assigned to them than because the default of their whole grouping would less impact on the whole portfolio. Diversification, as in many smaller groupings reduces the portfolio's overall concentration risk. The concentration capital for a loan is calculated by the formula below.

The documentation icon which if selected retrieves documentation for that loan in the format of a document including its covenants and legal matters necessary for its future transfer. The documentation may be read on the terminal or downloaded from the screen to the disk-drive of the machine and printed.

The web page showing the columns above are on a web page which can scroll horizontally as well as vertically, thus allowing the user to see all columns in one line.

Concentration Capital is the capital needed by the bank to offset the concentration risk of a plurality of loans in the same countries and same industrial categories and sub-categories.

Concentration capital can be calculated in a number of ways including formulae being used currently by banks

The following is the process in the present invention for calculating concentration capital.

Concentration capital is calculated at two levels.
a. For each loan within an industry or sub-industry and
b. For all loans in one country.

The method for calculating Concentration Capital for Loans, uses the fields as described in (“Listing all the loans in detail”) and (“additional columns” above).

Loans in the portfolio are grouped by Country, Category and Category plus Sub-category (concatenated) and the loans are read:
(a) within each country;
(b) within each category and
(c) within each subcategory.

These displayed fields in above are calculated in the following way:

Calculation for each loan's Economic Capital by the following formula:
a Loan Amount times
b Maturity months to run for loan times
c Expected default frequency or the loan's risk of default as percentage, times
d Loss given default, as a percentage of collateral expected to be recovered in case of a default times.

EC=L×M×EDF×LGD

Where “EC” is economic capital, “M” is the months left to run until maturity, “EDF” is the Expected Default Frequency and “LGD” is the loss given default or how the bank expects to recover in the case of a default, from the collateral.

The “Proportion of Economic Capital” is the proportion of the Economic Capital for each individual loan in the loan group, over the total economic capital for that group, expressed as a percentage. This is the proportion of the group's total economic capital that each loan contributes to the economic capital of the whole group.

P=(i . . . n)ΣE/G

Where E is the economic capital of a loan in the group, G is the economic capital of the whole group and P is that loan's contribution to the group expressed as a percentage. (i . . . n) are the number of loans in the group. P is the proportion that this loan's Economic Capital within the whole group's Economic Capital.

The individual loans economic capital is divided by the whole portfolio's total economic capital. This results in the proportion each loan has contributed to the whole portfolio's total economic capital. This value is used in the calculation of concentration capital, see below.

E=(i . . . n)ΣI/T

Where I is the economic capital of the individual loan, T is the economic capital of the whole portfolio, E is the proportion of economic capital of each loan. (i . . . n) is the number of loans in the loan group. E is used in the calculation of T (Total Group Proportion), see below.

The economic capital proportions for each loan are totaled up to give a total of these proportions for the whole group.

T=(i . . . n)ΣE

Where E is each loan's economic capital proportion of the portfolio, and T is the total of these proportions for the whole group. (i . . . n). T is used in the calculation of concentration capital, see below.

The “Concentration Amount for the loan”, is the loan's individual Economic Capital times the Total Group Proportion in, see above, giving the value representing the concentration amount of the loan.

C=E×T

where “E” is the loan's economic capital and “T” is the Total Group Proportions. The “Concentration Amount for the Loan”, above, divided by loan amount, gives the concentration percentage for each loan or how much of each the concentration amount it takes up.

P=C/L

Where C is the concentration amount, L is the loan amount and P is the concentration percentage of the loan.

The sum of all concentration percentages for the group is the group's concentration percentage of the portfolio and can therefore be compared to other concentration group's percentages.

Concentration capital is calculated in the above way, for all loans:
1. for each loan;
2. for each country and
3. for each category plus subcategory

The calculation of concentration capital for loans grouped by each country is done in a different way than for industrial category and subcategory. In the present invention the country concentration capital is calculated in the following way:
1. Input of subjective weightings for each country, signifying the perceived risk in lending to borrowers in that country.
2. Calculate the totals of economic capitals by each country, for all loans in that country, using the formula described below.
3. Calculate the proportions of Total Economic Capital, for all loans in each country, using the formula, see below.

Totals of Economic Capital which are the total of all loans in each country.

T=(i . . . n)ΣE

Where “E” is economic capital for each loan and “i” to “n” is the number of loans in a country. “T” is the total economic capital for all loans in a country.

The country concentration risk is calculated using both the “subjective weightings” below and the “proportions of economic capital” below for each country.

Subjective weightings are a percentage with 10% being a low likelihood of default and 90% being a high likelihood. The weighting can be derived from a rating agency's rating for that country, such as Moodys, KMV, Fitch and Standard and Poors. The percentage weightings for each country, are estimated by the bank. The subjective weightings can also be derived from the bank's internal rating or that of a rating agency's rating for this country. The Country Proportions of Economic Capital are the total of the country's economic capital divided by the total economic capital in the whole portfolio expressed as a percentage.

C=(i . . . n)ΣT/P

Where “T” is the total economic capital for each country, “P” is the total economic capital for the whole portfolio, (i . . . n) are the countries in the portfolio and “C” is the proportion of the country's economic capital to that of the whole portfolio.

The “Final Country Weightings” are the average between the Subjective Weightings and the Country Proportions of Economic Capital, above.

F=(S+C)/2

Where “S” is the subjective weightings, “C” is the Country Proportions of Economic Capital “F” is the final country weightings.

The Concentration Capital is also calculated by measuring the differences in the totals of economic capital between each country with the rest of the countries, to produce “Country Variances”.

If all countries had the same economic capital totals, this would denote the risk is spread evenly between countries, denoting “perfect diversification” between the countries and minimizing concentration risk. However if one country had a substantially different total of economic capital to another country, then there would be less diversification and more likelihood of greater concentration risk attaching to that country.

The “Country Variances” are calculated by the method described below:

Economic Capital is totaled for all countries. Each country's total economic capital is compared to each other country's economic capital producing “Country Variances”. The differences between them are divided by the portfolio's total economic capital and expressed as a percentage.

The “Country Variances” are calculated:

Ci=(i . . . n)Σ(C1−C2)/P

Ci is one country's variance. (i . . . . n) is each country. Where “C1” is the total economical capital for one country one and “C2” is the total economic capital for another country two. “P” is the economic capital for the whole portfolio. The differences between economic capitals are divided by the economic capital for the whole portfolio. “Ci” are all the “Country Variances” calculated for all countries with regard to all other countries. All Country Variances are expressed as a risk percentage of the first country, “C1”, being calculated against the second country, “C2”, as in the above calculation.

The “Final Country Weightings”, above, are combined with the “Country Variances” in above, by taking an average of the two, to produce the Final Concentration Risk as a percentage risk value for each country.

T=(F+C)/2

Where “F” is the Final Country Weightings, above, and “C” is the “Country Variances” above. “T” is the “Country's Total Concentration Weighting” expressed as a percentage.

The “Concentration Capital for Countries” and the “Concentration Capital for Loans”, by category with a subcategory, is additive. Each loan will therefore carry a proportion of the concentration capital for their country as well as concentration capital for their category and subcategory.

In the present invention the exchange of loans between the primary bank and the counterparty bank is hereby described.

In the present embodiment of the system loans are exchanged using the technical architecture described in FIG. 1.1, each bank being equipped with the system for electronically exchanging loans between the banks, using web pages, web services and their relational databases.

“Reverse matching” which enables banks to automatically exchange the optimum loans, is accomplished by the following programming process and is further displayed in FIGS. 1.6.0, 1.6.1, and 1.7.

The primary bank and the counterparty bank exchange loans using the Exchange Sheet shown in FIG. 1.7. Both banks have identical versions of the Exchange List. On the primary bank's version, their own loans will appear in the panel on the left hand side and counterparty's loans on the right hand side. For the counterparty, the loans in their version of the Exchange Sheet, will appear in the panel on the left hand side and the primary bank's loans will appear in the second panel on the right hand side.

Before loading their loans into their Exchange Sheet, by pressing the “Load Loans” button, the loans can be loaded with a number of options.

To order the loans in the desired order, the primary and counterparty banks, can choose via the first dropdown list box “Order Loans by”, (on the screen in 1.7) to order the loans by any one of the following: Borrower name;
i. loan group;
ii. loan amount;
iii. concentration capital or
iv. economic capital.

The loans will appear on the primary and counterparty bank's Exchange Sheets in one of these orders. The default order will be by concentration capital.

The primary and counterparty banks can choose the type of capital to use for matching loans, with the “Capital” drop down list box. These can be one of:
i. Concentration Capital of the loan or
ii. Economic Capital of the loan.

The default capital to diversify with is “Concentration Capital” as calculated above.

The primary bank can also load ad hoc groups of loans by entering their unique ‘Loan No’s in the retrieval parameters ‘From Loan No’ and ‘To Loan No’. This results in the loading of records from the Loan Table, see above, using the Loan Number in item 1.

If the primary bank enters a value in the “Loan To” field but no loan value in the “Loan From” field, this signifies that loans from the first loan on file up to the “Loan To” value are to be loaded. If a value is put in the “Loan From” parameter and no value in the “Loan To” field then the loans are loaded from the “Loan From” field to the end all loans filed.

The primary bank can also enter a particular concentration group by entering the country, category, subcategory and borrower into the textboxes so named on the Exchange Sheet. This will retrieve all the loans only in the concentration group.

The primary bank can retrieve a number of particular loans by entering their unique loan numbers in the drop down list box named “Loans”. A series of loans could be entered here by typing the loan numbers in succession into the drop down list box. The loan ids are found by the “Loan Listing” report.

If no options are used by either the primary or counterparty bank, then the default retrieval for the primary bank's loans is the concentrations groups with the highest concentration capital first and within the counterparty bank's the concentration groups the loans with the lowest concentration capital first.

When the primary and counterparty banks depress the “Load Loans” command button in the Exchange Sheet (shown in FIG. 1.7) the loans are loaded to each side of the screen according to the options chosen above. The loans are ordered by concentration capital or economic capital as chosen, see above.

When the loans are loaded each bank has the opportunity to make a number alterations to the list of loans on their Exchange Sheet.

Entering an “ ” or space in the Match column will stop the matching process matching that particular loan when the “Match loan” button is depressed. These may be loans which the primary bank or counterparty bank does not want to exchange because of their relationship to the client involved.

Entering “M” in the loan in the Match column will signify that loan is for matching and therefore will be matched during the matching process. The default is a “M” for matching the loan.

Loans by default will have “D” in the “Display” column signifying the loans is to be displayed, but with the Borrower name de-identified. De-identification of a loan is where the string with borrower's name is changed to a encrypted string to prevent the borrower name of the loan being seen by the counterparty bank. The borrower on the counterparty's loans similarly cannot be seen by the primary bank. The loan's country, category with sub-category, loan amount and all other aspects of the loan remain visible by both banks.

Entering an “R” in the “Display” column of the Exchange Sheet will re-identify the loan to the counterparty bank allowing the bank to see the borrower's name.

Allowing the primary and counterparty banks to see the borrower names of the other bank, therefore, must be done as a conscious step by the bank and not by default.

Entering “ ” (space) in the “Display” column will remove it from displaying to the counterparty bank.

Entering “ ” (space) in the “Match” column will stop it being matched with the counterparty bank.

Entering “ ” (space) in the “Exchange” column will remove it from being exchanged with the counterparty bank's loans.

“Match Loans” button can be depressed. The processes described in FIGS. 1.6.0 and 1.6.1 are then executed.

The “reverse matching” process is hereby described—

The loans in the primary bank's portfolio are sorted by the largest loans first. Loans from the counterparty bank's portfolio are sorted by the smallest loans first.

The system then “loops” through the primary bank's loans in order, reading each loan in turn. For each loan in the primary bank's portfolio encountered, the system then “loops” through the counterparty bank's portfolio examining each loan for their respective county, categories and sub-categories.

The details of the matching process is done by the following means:
1. Select the next loan in the primary bank's portfolio which is the largest unmatched loan available for matching with counterparty using its loan amount, see above.
2. Select loans in the counterparty bank in the counter-party bank's portfolio which are:
   a. less in amount than the loans in the primary bank's portfolio and
   b. have anyone of a different country, category, sub-category to the primary bank's portfolio (see FIG. 1.6.0).
3. Keep on selecting more loans in the counter-party bank's portfolio until the total loan amounts are greater than or equal to the primary bank's loan amount allowing for the threshold (as below). The total of the counterparty loans should be approximately equal to the primary's loan amount but still within the threshold percentage input in FIG. 1.7. and explained (as below).
4. When one or more loans from counterparty bank have been matched up to the loan amount from the primary bank loan, both the primary and counterparty's the loan's record are updated with “M” in the “Matched Indicator” to halt further matching of these records.
5. The primary bank's loan number is updated into the “Matched Loan Number” of the counterparty's records, for future traceability (see above) and (See FIG. 1.6.0).

The matching results in the loans in the primary bank's Exchange Sheet (that is the left hand panel in FIG. 1.7) matching against the loans in the counterparty bank's Exchange Sheet (that is the right hand panel in FIG. 1.7). In addition the matching reflects the loans which have the highest concentration capital first and at the same time have either a different country, category or sub-category. Their exchange will therefore reduce the concentration risk of both portfolios to the maximum amount.

During the matching process the system will have to deal with the situation where the counterparty's loans come to more in total than the loan from the primary bank. This gap between the counterparty's total loans and the primary bank's loan, is mitigated by the fact of matching a number of smaller loans with the primary bank loan, that is a smaller granularity in the counterparty's loans. However there will nearly always be the situation where the counterparty's loans do not equal the primary bank's loan.

In the above case the party with lower total will have to pay a “cash transfer” representing the short fall to the other party. This it is normally the counterparty making this advance for their shortfall to the primary's loan.

The primary or counterparty may pay the other party this difference depending on whether the total counterparty loans are above or below the primary loan (usually below). The cash transfer is recorded and sent to the other party electronically for approval and payment. It will consist of a document recording the transfer of loans with the “leveling amount” of cash to make it cost neutral (that is there not further payment due on either side). During the matching the dissimilarities between the primary loans and the counterparty loans will increase, making larger and larger differentials in the matching of the two sets of loans. The exchange of loans will increasingly depend on using the “Cash Advance” by either the primary or counterparty banks to level the exchange financially and thereby to facilitate it.

At the beginning of the matching process, there will be a lot of smaller loans, which have different country, category or sub-category, and these loans can be easily accumulated so as to equal the value of the primary bank's selected loan. As matching goes on however and the process gradually depletes the loans in the primary bank's and counterparty bank's portfolio which are easy to equivalence with the primary bank loans. The automated “reverse matching” process, used by the present invention, is illustrated in FIGS. 1.6.0 and 1.6.1 “Reverse Matching” and in 1.7 “Exchange Sheet”, and “Workflow of and Loan Exchange”, 1.7.1. It must be noted that the matching process can only be initiated by both banks simultaneously by pressing the “Match Loans” command button.

After the matching process is completed, the loans in the primary and counterparty a banks are redisplayed on the Exchange Sheet for further review by the banks

Therefore the counterparty bank's list of loan records the “Match Number” column will be filled with the loans matched from the primary bank's Exchange Sheet (FIGS. 1.6.0, 1.6.1 and 1.7). The primary bank's Match Number is filled with the first matched loan from the counterparty's list of matched loan records.

The primary and counterparty banks then have an opportunity to replace the numbers in the “Match” column with other loan numbers they specifically want to match. These loan numbers may be ones displayed on the other bank's Exchange Sheet or the Loan Listing in FIGS. 1.2.0 and 1.2.1. In addition they could be ones not displayed on the Exchange Sheet, such as another specific loans the banks have agreed to exchange. The banks will therefore agree to specific “manual exchanges” by negotiation and entering the loan numbers into their respective Exchange Sheets. These loans will be added to the end of the loan list on the Exchange Sheet.

The primary bank may not want to exchange one of the loans selected by the reverse matching process, in which case the bank enters “ ” (space) in the match column and Exchange columns for the loan, ensuring it will not be exchanged after the “Exchange Loans” command button is depressed.

The banks can also choose the method of exchange. “P” or “C” is entered into the “PHYS CDS” column of the Exchange Sheet (in FIG. 1.7 below), for each matched loan denoting whether to transfer loans by physical exchange, or by credit default swap. If the exchange method is different between the two banks the loans won't be exchanged until an agreement is made between the primary and counterparty banks

On pressing the “Exchange Loans” command, the matched loans are transferred and written into their respective databases (deleted in the home portfolio and inserted into the exchange target portfolio) and the savings of concentration capital in both portfolios explained above is shown FIG. 1.7.

In detail, when the primary and counterparty banks have pressed the Exchange Button the following technical steps occur:
1. the primary bank's loan table is read and the loans are selected in descending sequence;
2. For each primary bank's loan, all the counterparty bank's loans are read with their matched number, see above, equal to the primary bank's loan number;
3. the loans which have been matched on the Exchange Sheet are extracted into “Exchange tables” in each bank's databases;
4. the extracted loans are transmitted over the internet to the primary and counterparty bank's databases;
5. the primary and counterparty bank's systems incorporates the new loans into their databases;
6. Exchange fields of the counterparty are updated with the primary loan's unique Loan No and
7. Each bank's system redisplays the Loan Sheet with the exchanged loans.

The matching process is shown in FIGS. 1.6.0 and 1.6.1. The Exchange Sheet is shown in FIG. 1.7. The Workflow of the Matching Process is shown in 1.7.1.

Printed or electronic confirmations of the transfers are generated and transmitted to the primary and counterparty banks

The loan matching process is concluded

In another embodiment of the system, instead of reverse matching single loans between the portfolios, instead of matching single loans, the system matches loans within the highest Concentration Groups in both bank's portfolios. This is input in FIG. 1.7 as “Match by Single Loan or Concentration Group”.

In this embodiment, the bank's systems firstly groups the loans by country and category and sub-category, each comprising a “concentration group”. The concentration groups are then ordered by those with the highest total concentrations of capital first for both the primary bank and counterparty banks

Within the Primary Bank's concentration group the loans are ordered in descending sequence. Within Counterparty Bank's concentration group the loans are ordered in ascending sequence.

Within the primary bank's first concentration, the primary bank's system then “loops” each loan within first concentration group.

For each loan retrieved, above, the Primary Bank's system loops through the Counterparty Bank's loans within their highest concentration group

In this way the primary bank can “target” the highest concentration groups and match against the highest concentration groups of the Counter Party bank.

In this embodiment, by either or both banks entering a concentration group, the banks can successively target their “worst” concentration groups, from the point of view of being the highest groups in the portfolio, or the groups which are near to or over their limits.

It should be noted that for matching loans, concentration groups with the same Country, Category and Subcategory between the Exchange Sheets are ignored by the process, as matching their loans would not save either bank's concentration capital.

This concludes the explanation for the “Group Reverse Matching Process”.

In another embodiment of the system, the primary bank will exchange loans with multiple counterparty banks, instead of a single counterparty bank, in a group called an “Exchange Syndicate”. The exchange of loans, called “multi-bank matching”, between members of the Exchange Syndicate will be in the same way as for one counterparty bank. The architecture for exchanging in an Exchange Syndicate is shown in FIG. 1.8 below.

The method for exchanging loans to multiple banks in a Exchange Syndicate is hereby described.

The architecture for the Multiple Banks in a Loan Exchange is shown in FIG. 1.8 overleaf.

The screen for multiple bank matching is identical to that of reverse matching between two banks, except instead of the counterparty bank's name, in “Counterparty Bank's Exchange Candidates”, the heading “Exchange Syndicate” appears signifying the bank is reverse matching with all the banks of the Exchange Syndicate.

All the banks in the Exchange Syndicate will be in communication with each other over the internet and each bank will have an Exchange Sheet and will be able to exchange loans with the other banks in the Exchange Syndicate.

All the loan portfolios of each bank in the “Exchange Syndicate” are loaded onto a central server computer. All the loans are imported and “pooled” into a central database and into one table called “Multiple Bank Loans”. Each loan has its bank name in the Multiple Bank Loans table, which is shown in the central server in FIG. 1.8.

The loans in the Multiple Bank Loans table are ordered by concentration risk, the highest concentration risk loans first. The loans in the Multiple Loans are ordered in ascending order. The loans are then matched in the same way as in Reverse Matching, above.

Each bank in the Exchange Syndicate, matches its own loans, with the loans on the Multiple Bank Loans table, in the same way as “reverse matching” between two banks as described above, except that instead of “reverse matching” against a counterparty bank's loan portfolio, the primary bank is matching against the Multiple Bank Loans table with loans derived from all the Exchange Syndicate banks

As each loan in the Multiple Bank Loans table is successfully matched by a bank, the loan is updated with the loan number of the matched loan, in the “Matched No”, above, and an “M” in the Matched Record Indicator, above, making it unavailable for further matching with another bank.

After the loans of the primary bank, have been matched and exchanged, with the loans of all the banks in the Exchange Syndicate, each loan, which was transferred to the corresponding bank's portfolio, will have its original loan number, from the syndicated counterparty bank's portfolio, updated into its “Exchange No” field, (see above) and also the originating bank's name (see above), allowing traceability of the loan transfers.

In a further embodiment of the invention, the primary bank can select one bank from the Exchange Syndicate banks with which to reverse match and exchange loans with (as described above). The primary bank will exchange loans within the loans of that bank only, having retrieved that bank's name by entering the name in the “Syndicated Counterparty Bank” field in the Exchange Sheet in FIG. 1.7. These bank loans are reverse matched in the same way as for matching with a single counterparty.

The primary bank will therefore match against one bank after another, in this way, achieving a higher diversification than may be possible against a single counterparty. Banks in single or multiple bank exchange of loans may in addition to the Exchange Sheet screen, may have “out of band” communications (outside the system) with the counter party bank identified by bank name, using, but not limited to, email, instant messaging, telephone and Skype. The Exchange sheet itself will supply “peer to peer” communications by allowing the two banks to see each others inputs as they occur instantly on their screen. This out of band communications is when the primary bank and syndicated counterparty bank need to negotiate for the purpose of manually exchanging loans.

The banks sometimes will not be able to respond to a client's request for a new loan or an extension of an existing loan or a line of credit. This may be because to originate the loan the bank would need to exceed a limit placed for that country, that category and subcategory or that client. It may also be that the origination of the loan would result in an unacceptable increase in economic capital or concentration capital.

The process of “Remote Origination” is hereby described.

The Remote Origination process allows the bank to avoid the situation of not being able to originate a loan because of credit limits. Credit limits can be placed on a country, industry category, category plus sub category, ad hoc group of borrowers and single borrowers (described below). The credit limits indicate that no loans over the limit may be originated without approval of a governing body such as the board of directors “Remote origination” of loans allows one bank to originate a loan into another bank's portfolio without creating any liability in their own portfolio (see FIGS. 1.9 and 1.10)

The primary bank firstly originates and fills in the required details in the FIG. 1.10. The loan is assigned a unique number by the system and it is displayed in the “Loan No” field.

The bank enters the counterparty bank's name and how the transfer will be done, by physical exchange or by credit default swap (CDS).

The bank then presses the “Originate Loan” command button, the loan is written into the primary bank's portfolio.

The loan is then transferred to the counterparty bank's portfolio with the status of the loan is set to “pending origination” in the status field of the primary and counterparty bank's portfolios, described above. The loan details and status appears on their Loan List in FIG. 1.2.1 and Exchange Sheet in FIG. 1.7.

The counterparty bank the brings the loan up using the screen in FIG. 1.10 using the unique loan number and displays the status of “Pending Origination” which is updated to the loan's loan status field.

Both banks inspect the loan before both pressing the button “Transfer Loan”. Both banks need to depress the “Transfer Loan” command before the loan is transferred. The loan is copied from the originating bank's portfolio and written to the counterparty bank's portfolio with the loan status of “Transferred” in the loan records of both the primary and counterparty's portfolios (described above). The loan can be either physical or by CDS and the method transfer is reflected in the Status field of the Loan Tables. The exchange of the loan is reflected in both the Loan List in FIG. 1.2.1 and the Exchange Sheet in FIG. 1.7.

The “Remote Origination No” on the counterparty bank's portfolio, described above, is updated with the primary (originating) bank's loan number, signifying it was a remotely originated loan and providing traceability of the transaction.

The relevant documentation is then exchanged between the primary and counterparty bank, completing the transfer.

The client of the originating bank is then informed that their application for the loan or credit line has been accepted.

Remote origination (see FIGS. 1.9 and 1.10 below) provides banks with a convenient and safe way to originate loans without the liability of their credit risk, concentration capital or credit limits, outlined below. In addition the counterparty's portfolio may also be diversified by the remote origination.

This completes the explanation of remote origination.

In this embodiment the bank would utilize the system to place credit limits on their lending. They would place limits in a screen shown in FIG. 1.11.

In the screen the bank would enter limit amounts to one or more of the Country, Category, Category with subcategory, group of borrowers and a single borrower.

The group of borrowers is identified by a drop down list box in which the bank can also enter a list of borrowers, for a credit limit, using their unique numbers as assigned by the system.

The screen displays current usage including the total of all current loans over their limits as previously set. For example “195.1/200.00” showing 195.1 million dollars of loans out of a limit of 200.0 million.

For any limit that had been already breached, the current usage would be highlighted in red.

The system allows the bank to originate a loan locally (instead of remotely) into their portfolio, within their credit limits, as in the Origination Screen in FIG. 1.12 below.

With remote origination, described above, the bank can originate loans which do not breach a credit limit which would otherwise be breached.

While entering a new loan, the bank can view existing credit limits, using the screen in FIG. 1.11 the “Limits Screen”, which can display and set limits by country, category, category with subcategory, borrower group or borrower.

The Limit Type can be “Hard” over which the primary bank cannot originate the loan, or “Soft” where the loan can be originated but it will be flagged in the Limits Monitoring screen, with the loan shaded, as shown in “Limits Monitoring” screen FIGS. 1.13.0 and 1.13.1.

The “limits monitoring screen” is a special way to display credit limits using colorized bars denoting successive levels of credit limits for:
1. Country;
2. Category;
3. Category and Sub-category; Borrower group and
4. Single borrower.

The borrower group may include for example a large energy company with a number of “partner” companies and subsidiaries, which the bank wants to control as a group.

The Limits Monitoring Screen's column “over/under” contains the following information as follows:
1. if no credit limit applies to this loan, the column is blank.
2. if one or more credit limits apply, the “operative credit limit” is put in this field. This amount is equal to the borrower limit, but if none then; borrower group limit, but if none then;
   a. category and subcategory limit, if none then;
   b. country limit, if none then;
   c. no limits apply (blank in the column).
3. The loan cell (distinct column and row) as well as reflecting the loan's amount is also covered by the color of the operative credit limit, visually signifying that it is subject to a limit and which limit (country, category, subcategory, borrower group and borrower).
4. how much in total has been used by each limit in the form for example 123/125 denoting that 123 million has been used from a limit of 125 million.
5. the format of the over/under column is “nnn/mmm” where “nnn” is the amount by all loans in the group and “mmm” is the limit as set for this group. In this way the primary bank knows how “near” they are to breaking a limit applying to a loan.

The credit Limits Summary screen (see FIG. 1.13.2) shows a summary of each limit. The bank enters the country, category, category/category, borrower group and borrower that they wish to summarize and the report shows:
1. the size of the limit and
2. the usage of the limit.

The report can made for each particular country, category, category/category, borrower group and borrower or for the whole portfolio.

This concludes the explanation of credit risk limits and the current invention.

In another embodiment of the system, the measurement of concentration capital, is used for portfolios of other assets than for loans, including for stocks, bonds, futures, derivatives (such as options on stocks) and collateralized debt obligations (or “CDO's”) (below).

In this embodiment, the financial institution is able to exchange financial assets other than bank loans, including stocks, bonds, derivatives (such as options) and Collateralized Debt Obligations (below], using the present invention's calculation of concentration capital and the method of exchanging securities directly with one or more counterparties.

In this embodiment of the system assets may be exchanged directly with a counterparty, without trading in the open market and thereby without making the portfolio manager's buys and sells public knowledge. Trading directly with a counterparty (as opposed to trading on the open markets) also allows the primary bank to perform “due diligence” on the counterparty bank (investigate the financial and credit worthiness) of the counterparty bank.

In this embodiment of the system the loans which the bank needs to have exchanged from their portfolio with another bank, can be exchanged to another financial institution which is securitizing a Collateralized Debt Obligation or “CDO” for sale as a “fixed income security” to the general public (see FIG. 1.14 below).

The portfolio of assets within a CDO are made up of debt instruments including bank loans. The structure of a CDO is similar to a counterparty bank's loan portfolio. In the case of a CDO however, the CDO does not generally exchange loans back to the originating bank but instead pays the bank a financial amount for the loans according to their size, expected default frequency, economic capital and concentration capital.

The same process of calculating concentration capital and Reverse Matching can be applied between the primary bank's loan portfolio and the CDO as shown in “Trading Financial Instruments Collateralized Debt Obligations” the FIG. 1.14 below.

Banks can exchange other financial instruments such as investment vehicles including financial securities which they would normally trade on the open markets. The reason also for banks and other financial institutions choosing exchanging, as opposed to trading on open markets, would be that the banks and financial institutions would avoid other companies knowing their buys, sells and holdings. Also the price of loans traded in a liquid market would be subject to sudden price shifts which were not in the interest of the bank or the borrower. Finally the primary bank can perform due diligence on the counterparty bank as discussed in above. The process is almost identical to exchanging loans and the architecture for this type of direct exchange is shown in FIG. 1.15.

In the present embodiment of the invention, the workflow of the current invention is described in “Workflow for Exchanging Loans and Financial Instruments” in FIG. 1.16 below.

Further the system can also be used to measure concentration capital for assets in a plurality of different portfolios including loans, bonds, stocks and derivative securities. It can then be used to diversify these assets by exchange trading assets with CDOs and other securitization vehicles in a similar way to exchanging loans in two portfolios (above).

The foregoing algorithms for the purpose of calculating concentration capital can be equally applied to such other vehicles with minor modifications, by one skilled in the art.

This would facilitate “offline” or “direct” trading between portfolio holders without going through open markets such as the stock exchange for the reasons mentioned above. As discussed, this could be an alternative where a portfolio holder does not want to publicize their holdings, trades or other aspects of their portfolio to an open market.

In conclusion the system provides six major functions.

Firstly the system stores and retrieves bank's loans within a loan portfolio and allows banks to view and report the portfolio over the web.

Secondly the system provides the calculation of concentration capital in two or more bank's loan portfolios.

Thirdly the system facilitates the exchange of loans between two or more bank's portfolios by physical transfer or means of credit default swaps, in order reduce their portfolio's concentration capital or meet credit limits.

Fourthly, the system allows one bank to originate and immediately transfer the loan into another bank's portfolio, by a process known as “Remote Origination” (described above and FIG. 1.9) and by this the primary bank can avoid accumulating concentration capital or exceeding credit limits on a country, category and subcategory, borrower group or individual borrower.

Fifthly the system allows the primary bank to enter a number of credit limits on their portfolio and see the status of credit limits within the portfolio. The banks can then exchange or remotely originate loans with the counterparty bank without breaching credit limits.

Sixth, is a means for banks to interact with financial companies who are securitizing loans and debt instruments into Collateralized Debt Obligations enabling the bank to sell off highly concentrated or risky loans.

Banks in this document refer to banks and lending institutions.

The foregoing description, for the purposes of explanation, used specific nomenclature to provide a thorough understanding of the invention. Having shown and described various embodiments of the present invention, further adaptations of the method and systems described herein may be accomplished by one of ordinary skill in the art without departing from the scope of the present invention. Several of such potential and alternative embodiments have been mentioned, and others will be apparent to one skilled in the art. They are not intended to be exhaustive or to limit the invention to the precise forms disclosed. Many variations are possible in view of the above teachings. The embodiments were chosen and described in order to best explain the principles and computer interfaces of the invention and its practical applications, to thereby enable others skilled in the art to best utilize the invention and its various embodiments with various modifications as are suited to the particular use contemplated.

We claim:

1. A computer-implemented method carried out on a non-transitory computer-readable medium for exchanging loans between a plurality of banks comprising the steps of:
analyzing a portfolio of loans in a loan portfolio to determine concentration risk in at least two banks,
calculating concentration risk capital to be retained by the bank, at each said bank, based on said determined concentration risk;
determining at least one loan, at each of a first and a second bank or said plurality of banks to be exchanged between said first and said second bank which will cause a decrease in said concentration risk for each of said first and said second banks.

2. The method of claim 1, further comprising a step of exchanging or facilitating the exchange of a plurality of loans between more than two of said banks or lending institutions which decreases said concentration risk for each said bank or lending institution involved in said exchange.

3. The method of claim 2 further comprising a step of exhibiting a visual representation of transfer of data, in order to optimally diversify their portfolios and reduce said concentration risk capital in each bank.

4. The method of claim 1, wherein said determining of concentration risk is based on a determination based on each country, each industry category, each industry sub-category, each user entered group of borrowers and each borrower.

5. The method of claim 1, further comprising a step of automatically matching loans between the said first and said second bank, such that, when exchanged, such an exchange will reduce the concentration risk in the said first and second bank.

6. The method of claim 1, further comprising a step of automatically matching loans between more than two of the said banks, such that when exchanged, will reduce the concentration risk in each of the said two or more of the said banks.

7. The method of claim 1, where the first said bank originates a new loan, the concentration risk of which, is immediately transferred to the second said bank whereupon no additional concentration risk or risk capital is incurred by the first bank based on said new loan.

8. The method of claim 1, wherein said exchange of loans between said first and said second bank are within a credit limit of each bank.
